(19) United States
(12) Patent Application Publication
(10) Pub. No.: US 2024/0428219 A1
(43) Pub. Date: Dec. 26, 2024

(54) COMMODITY REGISTRATION APPARATUS AND INFORMATION PROCESSING METHOD FOR A COMMODITY REGISTRATION APPARATUS

(71) Applicant: Toshiba Tec Kabushiki Kaisha, Tokyo (JP)

(72) Inventor: Kazuyuki SAKAI, Kawasaki Kanagawa (JP)

(21) Appl. No.: 18/584,770

(22) Filed: Feb. 22, 2024

(30) Foreign Application Priority Data
Jun. 26, 2023 (JP) 2023-104436

(51) Int. Cl. G06Q 20/20

(52) U.S. Cl. CPC G06Q 20/208

(57) ABSTRACT

In accordance with an embodiment, a commodity registration apparatus acquires, during commodity registration in one transaction, information regarding the operation by the customer, which is received by the customer display device. In addition, the commodity registration apparatus displays, on the basis of the acquired information regarding the operation by the customer, information indicating a progress status of the operation by the customer on the store checker display device.

### CROSS-REFERENCE TO RELATED APPLICATIONS

This application is based upon and claims the benefit of priority from the prior Japanese Patent Application No. 2023-104436, filed on Jun. 26, 2023, the entire contents of which are incorporated herein by reference.

### FIELD

An embodiment described here generally relates to a commodity registration apparatus and an information processing method for a commodity registration apparatus.

### BACKGROUND

As commodity sales systems for large retail stores such as supermarkets and hardware stores, there are systems in which a store employee called store checker as an operator inputs information associated with purchase commodities, such as barcodes added to the commodities.

In such a commodity sales system, during the checker's commodity registration, a customer waits for the checker to finish registering commodities while checking a registration statement or doing nothing. It takes long time until settlement processing starts.

### BRIEF DESCRIPTION OF THE DRAWINGS

FIG. 1 is a schematic configuration diagram of a commodity sales system according to an embodiment.

FIG. 2 is a block diagram showing a main part circuit configuration of an apparatus main body of a commodity registration apparatus according to the embodiment.

FIG. 3 is a schematic view showing a main storage area formed in a main memory according to the embodiment.

FIG. 4 is a schematic view showing a main functional configuration of the commodity registration apparatus according to the embodiment.

FIG. 5 is an example of a customer display image displayed on a customer touch panel according to the embodiment.

FIG. 6 is an example of the customer display image displayed on the customer touch panel according to the embodiment.

FIG. 7 is an example of the customer display image displayed on the customer touch panel according to the embodiment.

FIG. 8 is an example of a store checker display image displayed on a store checker touch panel according to the embodiment.

FIG. 9 is an example of the customer display image displayed on the customer touch panel according to the embodiment.

FIG. 10 is an example of the customer display image displayed on the customer touch panel according to the embodiment.

FIG. 11 is an example of the store checker display image displayed on the store checker touch panel according to the embodiment.

FIG. 12 is an example of the customer display image displayed on the customer touch panel according to the embodiment.

FIG. 13 is an example of the customer display image displayed on the customer touch panel according to the embodiment.

FIG. 14 is an example of the customer display image displayed on the customer touch panel according to the embodiment.

FIG. 15 is an example of the store checker display image displayed on the store checker touch panel according to the embodiment.

FIG. 16 is an example of the customer display image displayed on the customer touch panel according to the embodiment.

FIG. 17 is an example of the store checker display image displayed on the store checker touch panel according to the embodiment.

FIG. 18 is an example of the customer display image displayed on the customer touch panel according to the embodiment.

FIG. 19 is an example of the store checker display image displayed on the store checker touch panel according to the embodiment.

FIG. 20 is an example of the store checker display image displayed on the store checker touch panel according to the embodiment.

FIG. 21 is a flowchart showing an example of an information processing procedure by the commodity registration apparatus according to the embodiment.

FIG. 22A is a flowchart showing an example of the information processing procedure by the commodity registration apparatus according to the embodiment.

FIG. 22B is a flowchart showing an example of the information processing procedure by the commodity registration apparatus according to the embodiment.

FIG. 23 is a flowchart showing an example of the information processing procedure by the commodity registration apparatus according to the embodiment.

### DETAILED DESCRIPTION

In accordance with one embodiment, a commodity registration apparatus registers a commodity to be purchased by the customer. The commodity registration apparatus includes a customer display device, a store checker display device, and a processor. The customer display device displays a customer display image including various types of customer information and receives an operation by the customer. The store checker display device displays a store checker display image including various types of store checker information and receives an operation by the store checker. The processor acquires, during commodity registration in one transaction, information regarding the operation by the customer, which is received by the customer display device. In addition, the processor displays, on the basis of the acquired information regarding the operation by the customer, information indicating a progress status of the operation by the customer on the store checker display device.

### Embodiment

### Configuration Example

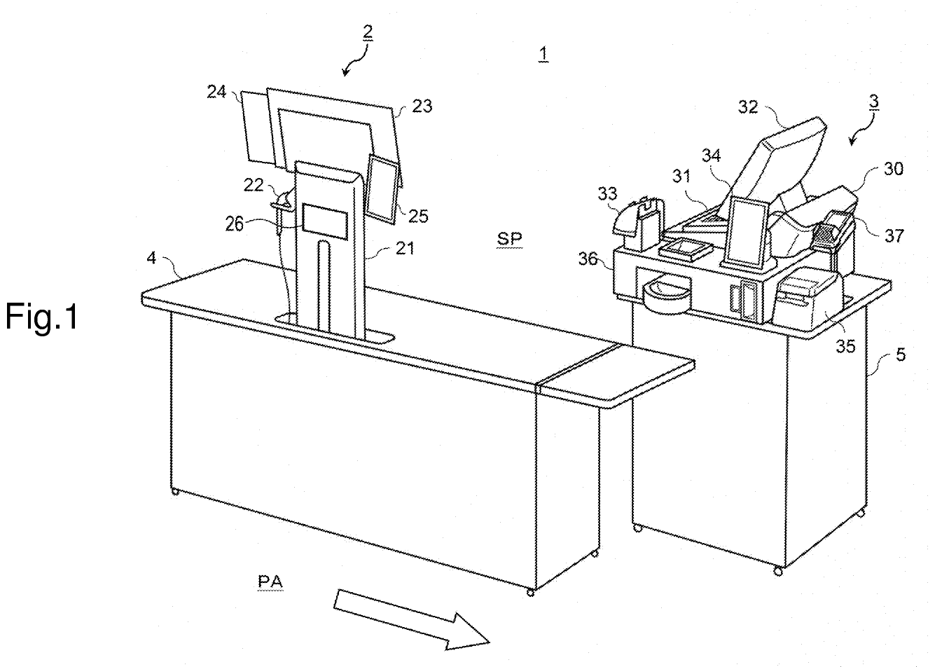

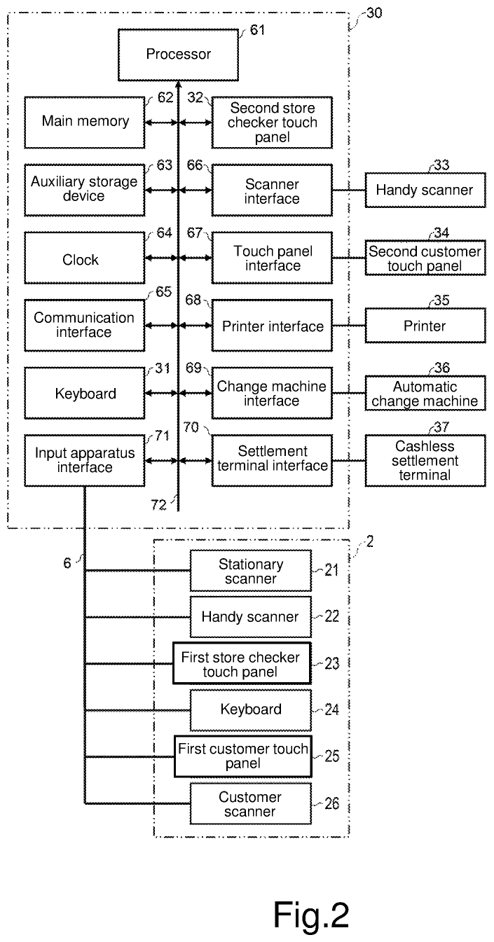

Hereinafter, an embodiment will be described with reference to the drawings. In each figure, the same components will be denoted by the same reference signs as long as it is possible and duplicated descriptions will be omitted. FIG. 1 is a schematic configuration diagram of a commodity sales system 1 according to the embodiment. The commodity sales system 1 includes an input apparatus 2 and a settlement processing apparatus 3. The input apparatus 2 is an apparatus for inputting information associated with a purchase commodity, such as a barcode added to the commodity. The settlement processing apparatus 3 is an apparatus for settling a transaction with a customer who processes sales data of the purchase commodity on the basis of information input via the input apparatus 2. The input apparatus 2 and the settlement processing apparatus 3 are connected to each other through a transmission cable. A computer in which the subject is a processor is mounted on the settlement processing apparatus 3. That is, the input apparatus 2 is a peripheral device externally attached to the settlement processing apparatus 3. The input apparatus 2 and the settlement processing apparatus 3 will be sometimes collectively referred to as a commodity registration apparatus. The input apparatus 2 and the settlement processing apparatus 3 are connected to each other through a communication cable like a transmission cable 6 (see FIG. 2) or USB such as a local area network (LAN) cable. The input apparatus 2 and the settlement processing apparatus 3 may be wirelessly connected to each other.

The input apparatus 2 is attached to a checkout counter 4. The checkout counter 4 is arranged along a path PA where a shopping customer walks in the arrow direction shown in the figure. The input apparatus 2 is attached to substantially the center of a top surface of the checkout counter 4. A space on an upstream side of the path PA with respect to the input apparatus 2 is a space where a purchase commodity before registration is placed. A space on a downstream side of the path PA with respect to the input apparatus 2 is a space where a registered purchase commodity is placed. The shopping customer can also be a customer, a purchaser, a user, a member, or a person.

The input apparatus 2 is an apparatus including a stationary scanner 21, a handy scanner 22, a first store checker touch panel 23, a keyboard 24, a first customer touch panel 25, and a customer scanner 26 as input/output devices. As to the input apparatus 2, the stationary scanner 21 is arranged protruding upward from the top surface of the checkout counter 4 and the handy scanner 22, the first store checker touch panel 23, the keyboard 24, and the first customer touch panel 25 are arranged in the periphery of this stationary scanner 21. The first store checker touch panel 23 is an example of a store checker display device. The first customer touch panel 25 is an example of a customer display device.

Specifically, the stationary scanner 21 is fixed to the top surface of the checkout counter 4. The stationary scanner 21 is a vertical-type scanner and is fixed so that a scanning window for the barcode is positioned on a surface on a side opposite to the path PA. The handy scanner 22 is engaged with a side portion of the stationary scanner 21. The first store checker touch panel 23 is attached to an upper portion of the stationary scanner 21 so that its operation panel surface is oriented in the same direction as a scanning window of the stationary scanner 21. The keyboard 24 is attached to a side portion of the first store checker touch panel 23 so that its key surface is oriented in the same direction as an operation panel surface of the first store checker touch panel 23. The first customer touch panel 25 is attached to a side portion of the stationary scanner 21 so that its display screen faces the path PA. The customer scanner 26 is attached to a side portion of the stationary scanner 21 so that its scanning window faces the path PA.

With such an input/output device, the store checker standing in a space SP on a side opposite to the path PA with the checkout counter 4 located therebetween can input information associated with a purchase commodity to be purchased by the customer, such as a commodity code, a purchase quantity, and a discount amount, by operating the stationary scanner 21, the handy scanner 22, the first store checker touch panel 23, or the keyboard 24. At this time, the store checker can check a commodity name, a unit price, etc. of the purchase commodity on the basis of information displayed on the first store checker touch panel 23. The customer can check the commodity name, the unit price, etc. of the purchase commodity on the basis of information displayed on the first customer touch panel 25. The customer can input information associated with check-out processing, such as whether or not the customer has a rewards card, selection of whether or not to purchase a shopping bag, whether or not the customer has a coupon, whether or not the customer has a gift card, etc., and selection of a payment method, via the first customer touch panel 25. The customer can perform scanning of a rewards card and/or a coupon code, for example, via the customer scanner.

The settlement processing apparatus 3 is an apparatus including a keyboard 31 and a second store checker touch panel 32 as devices integrated with an apparatus main body 30. Moreover, the settlement processing apparatus 3 is an apparatus including, for example, a handy scanner 33, a second customer touch panel 34, a printer 35, an automatic change machine 36, a cashless settlement terminal 37 as devices externally attached to the apparatus main body 30. The settlement processing apparatus 3 is placed on a top surface of a cash register counter 5 installed on a side opposite to the path PA near a downstream end portion of the checkout counter 4.

Specifically, the apparatus main body 30 is placed on the cash register counter 5 so that the key surface of the keyboard 31 and the operation panel surface of the second store checker touch panel 32 face the space SP where the store checker stands. The handy scanner 33, the second customer touch panel 34, the printer 35, the automatic change machine 36, and the cashless settlement terminal 37 are arranged in the periphery of the apparatus main body 30. A handy scanner 33 is positioned so that the store checker standing in the space SP can operate the handy scanner 33. The second customer touch panel 34 is positioned so that the customer standing on the path PA can visually recognize its display screen. The printer 35 is positioned so that the customer standing on the path PA can easily receive a receipt. The automatic change machine 36 is positioned so that the customer standing on the path PA can easily put in cash and take out paid-out money. The cashless settlement terminal 37 is positioned so that the customer standing on the path PA can easily operate the cashless settlement terminal 37 for performing cashless settlement such as credit card settlement, electronic money settlement, or code settlement.

With such an arrangement of the devices, the customer standing on the path PA can check information displayed on the second customer touch panel 34, such as information associated with payment of the price, right there. The customer can receive a receipt issued from the printer 35 right there. The customer who pays the price by cash can put the cash into the automatic change machine 36 and receive the paid out money while standing on the path PA. The customer who pays the price by cashless settlement can operate the cashless settlement terminal 37 and pay the price in a cashless manner while standing on the path PA. That is, the settlement processing apparatus 3 functions as a checkout machine.

In general, at a large retail store such as a supermarket or a hardware store, a plurality of commodity sales systems 1 with such a configuration is installed in parallel in a check-out place (cashier) separated from a sales floor where commodities are displayed. On the other hand, as to a compact retail store such as a specialty store, only one commodity sales system 1 may be installed at such a store.

FIG. 2 is a block diagram showing a main part circuit configuration of the apparatus main body 30 in the settlement processing apparatus 3. As shown in the figure, the apparatus main body 30 includes a processor 61, a main memory 62, an auxiliary storage device 63, a clock 64, a communication interface 65, a scanner interface 66, a touch panel interface 67, a printer interface 68, a change machine interface 69, a settlement terminal interface 70, an input apparatus interface 71, and a system communication channel 72, for example. The system communication channel 72 includes an address bus, a data bus, a control signal line, for example. The system communication channel 72 is connected to the processor 61 and the other respective blocks and transmits data signals exchanged therebetween.

The apparatus main body 30 connects the processor 61, the main memory 62, the auxiliary storage device 63, the clock 64, the communication interface 65, the scanner interface 66, the touch panel interface 67, the printer interface 68, the change machine interface 69, the settlement terminal interface 70, and the input apparatus interface 71 to one another through the system communication channel 72, thereby configuring a computer. Then, the apparatus main body 30 connects the keyboard 31 and the second store checker touch panel 32 to the computer via the system communication channel 72.

The processor 61 corresponds to a central part of the computer. The processor 61 controls the respective blocks in accordance with an operating system or an application program so as to realize various functions as the settlement processing apparatus 3. The processor 61 is, for example, a central processing unit (CPU). The processor 61 includes a plurality of processor cores and is a multi-core processor capable of executing a plurality of processes in parallel.

The main memory 62 corresponds to a main storage part of the computer. The main memory 62 includes a nonvolatile memory area and a volatile memory area. The main memory 62 stores an operating system or an application program in a nonvolatile memory area. The main memory 62 may store data required for the processor 61 to execute processing for controlling the respective blocks in the nonvolatile or volatile memory area in some cases. The volatile memory area for the main memory 62 is used as a work area in which the processor 61 rewrites data as appropriate. The nonvolatile memory area is, for example, a read only memory (ROM). The volatile memory area is, for example, a random access memory (RAM).

The auxiliary storage device 63 corresponds to an auxiliary storage part of the computer. For example, an electric erasable programmable read-only memory (EEPROM), a hard disk drive (HDD), or a solid state drive (SSD) can be the auxiliary storage device 63. The auxiliary storage device 63 saves data used for the processor 61 to perform various types of processing, data generated by the processing in the processor 61, and the like. The auxiliary storage device 63 stores the above-mentioned application program in some cases.

The clock 64 counts date and time. The processor 61 processes the date and time counted by the clock 64 as current date and time.

The communication interface 65 is an interface for performing data communication with a store server connected thereto via a communication network. The store server is a computer including a commodity master that has stored commodity data such as a commodity name, a unit price, etc. of each commodity sold at the store and for collecting and summing sales data of commodities processed by the settlement processing apparatus 3 and managing sales, stock, etc. of the entire store.

The scanner interface 66, the touch panel interface 67, the printer interface 68, the change machine interface 69, and the settlement terminal interface 70 are all interfaces for performing data communication with the device externally attached to the apparatus main body 30. That is, the scanner interface 66 performs data communication with the handy scanner 33. The touch panel interface 67 performs data communication with the second customer touch panel 34. The printer interface 68 performs data communication with the printer 35. The change machine interface 69 performs data communication with the automatic change machine 36. The settlement terminal interface 70 performs data communication with the cashless settlement terminal 37.

The input apparatus interface 71 is an interface for performing data communication with the input apparatus 2 connected to the transmission cable 6. That is, the input apparatus interface 71 performs data communication with each of the stationary scanner 21, the handy scanner 22, the first store checker touch panel 23, the keyboard 24, and the first customer touch panel 25.

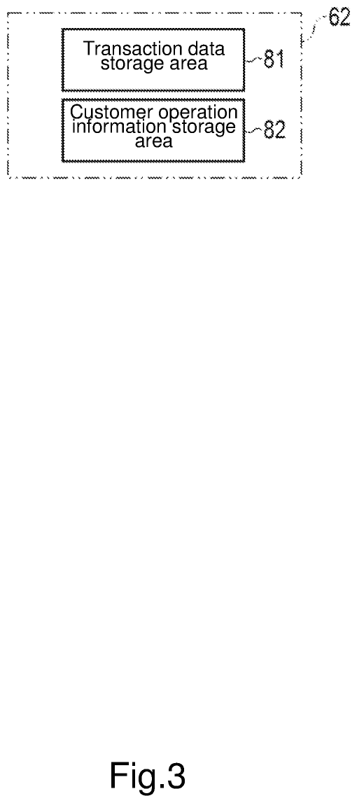

FIG. 3 is a schematic view showing a main storage area formed in the main memory 62. The settlement processing apparatus 3 uses a portion of the volatile storage area in the main memory 62 as a transaction data storage area 81 and a customer operation information storage area 82. The transaction data storage area 81 is an area for storing sales data of purchase commodities processed as one transaction. The sales data includes items such as a commodity code, a commodity name, a unit price, a purchase quantity, and a sales amount of each purchase commodity. The sales amount is an amount of money obtained by multiplying the unit price by the purchase quantity. The customer operation information storage area 82 is an area for storing customer operation information based on an operation by the customer.

The customer operation information includes a status for each customer operation item and operation information for each customer operation item, for example. The customer operation item includes, for example, selection of whether or not to purchase a shopping bag, entry of rewards cards, entry of coupons, entry of gift cards, etc., and selection of a wished payment method. The selection of whether or not to purchase a shopping bag includes inputs as to whether or not to purchase a shopping bag and selection of size and number of shopping bags to be purchased. The entry of rewards cards includes selection of whether or not the customer has a rewards card and scanning of the rewards card. The rewards card includes, for example, a card with a code readable by a scanner and a magnetic card readable by a card reader. The entry of coupons includes selection of whether or not the customer has a coupon with a coupon code and scanning of the coupon. The coupon includes a coupon with a coupon code readable by the scanner and a coupon with no coupon code. For example, in a case where the customer has a coupon with a coupon code, the entry of coupons includes selection of whether or not the customer has a coupon with a coupon code and scanning of the coupon. In a case where the customer has a coupon with no coupon code, the entry of coupons includes selection of whether or not the customer has a coupon with no coupon code. The entry of gift cards, etc. includes selection of whether or not the customer has a gift card, etc. with a code readable by a scanner or the like and scanning of the code. The entry of gift cards, etc. includes selection of whether or not the customer has a gift card, etc. The gift card, etc. includes, for example, a gift card, a complimentary ticket, and a discount ticket issued by a municipality. The gift card, etc. includes a gold note such as a beer token. In a case where the customer has a gift card, etc. with no code, the entry of gift cards, etc. includes selection of whether or not the customer has a coupon with no code. The selection of a payment method includes selection of a wished payment method such as cash, credit card, electronic money, or code settlement. The customer operation item is not limited to the above-mentioned operation items, and may be updated as appropriate by setting by a manager, for example. The customer operation item will be also simply referred to as an operation item.

The status for each customer operation item is an example of information indicating a progress status of an operation by the customer. The status will also be referred to as a progress status. The status for each customer operation item includes an operation start status, an operating status, and an operation end status. The operation start status denotes a status in which the customer operation is started. The operation start status includes a status in which a customer operation image for each operation item is displayed on the first customer touch panel 25. The operating status denotes a status from the operation start to the operation end. The operation end status denotes a status in which the customer operation is completed. The operation end status includes a status in which a customer operation image for the next operation item is displayed on the first customer touch panel 25. The status for each customer operation item includes an intervention-required status denoting a status in which intervention of the store checker is required. The status in which intervention of the store checker is required includes, for example, a case where the customer has a coupon with no coupon code and a case where the customer has a gift card, etc. In a case where the customer has a coupon with no coupon code, a task for the store checker to receive the coupon from the customer is required. In a case where the customer has a gift card, etc., a task for the store checker to receive the gift card, etc. from the customer is required.

The operation information for each customer operation item denotes information for each operation item based on an operation by the customer. For example, the operation information includes information indicating whether or not to purchase a shopping bag and information on selection of size and number of shopping bags to be purchased. The operation information includes information indicating whether or not the customer has a rewards card and card information of the rewards card. The card information is, for example, a rewards card number. The operation information includes information indicating whether or not the customer has a coupon and coupon information. The coupon information is, for example, a coupon code. The operation information includes information indicating whether or not the customer has a gift card, etc. The operation information includes information indicating a selected payment method.

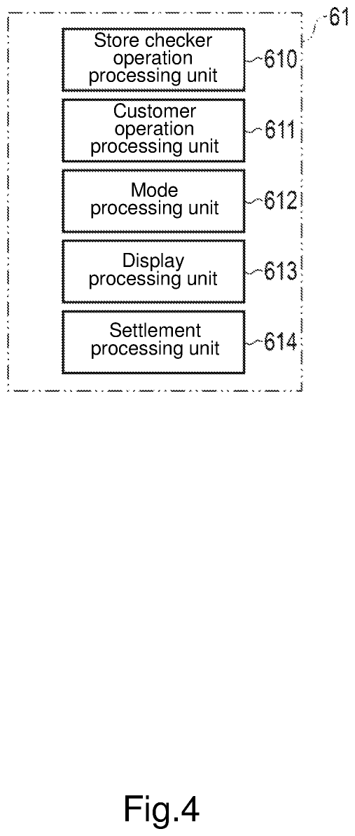

FIG. 4 is a schematic view showing a main functional configuration of the commodity registration apparatus according to the embodiment. The input apparatus 2 and the settlement processing apparatus 3 will be collectively referred to as a commodity registration apparatus. The respective blocks realized by the processor 61 of the commodity registration apparatus will be described. The processor 61 realizes a store checker operation processing unit 610, a customer operation processing unit 611, a mode processing unit 612, a display processing unit 613, and a settlement processing unit 614. The respective blocks realized by the processor 61 can also be said to be respective functions. It can also be said that the respective blocks realized by the processor 61 are realized by a control unit including the processor 61 and the main memory 62. Both are realized by information processing executed by the processor 61 in accordance with a service program.

The service program is a type of application program stored in the main memory 62 or the auxiliary storage device 63. There are no particular limitations on a method of installing the service program into the main memory 62 or the auxiliary storage device 63. An input program or a service program can be installed in the main memory 62 or the auxiliary storage device 63 by recording the input program on a removable recording medium or delivering the service program by communication via a network. The recording medium can take any form as long as it can store the program, like a CD-ROM or a memory card for example, and it can be scanned by the apparatus.

The store checker operation processing unit 610 acquires information regarding an operation by the store checker via the first store checker touch panel 23. Hereinafter, the information regarding the operation by the store checker will be sometimes simply referred to as an operation by the store checker. The store checker operation processing unit 610 starts reception of a customer operation on the basis of the operation by the store checker. The customer operation will also be referred to as an operation by the customer. The store checker operation processing unit 610 may start the reception of the customer operation on the basis of the store checker's touch operation on a customer operation reception start button or the like via the first store checker touch panel 23. The store checker operation processing unit 610 may start the reception of the customer operation on the basis of start of a commodity registration operation by the store checker. The commodity registration operation can be started on the basis of a touch operation on a start button of the first store checker touch panel 23. The commodity registration operation may be started on the basis of scanning of a barcode added to a purchase commodity by the stationary scanner 21 or the handy scanner 22.

The store checker operation processing unit 610 updates transaction data on the basis of a commodity registration operation by the store checker. The update of the transaction data includes processing of reading a commodity name, a unit price, etc. of a commodity identified by a commodity code from the commodity master, generating sales data of the purchase commodity including the commodity code, the commodity name, the unit price, the purchase quantity, the sales amount, etc., and writing them in the transaction data storage area 81 (FIG. 3) of the main memory 62.

The store checker operation processing unit 610 detects the store checker's touch operation on a subtotal button or the like. The store checker operation processing unit 610 reflects customer operation information to transaction data on the basis of an operation by the store checker. The store checker operation processing unit 610 performs reflection of information regarding selection of whether or not to purchase a shopping bag, reflection of reward points, reflection of a coupon, and the like to transaction data in one transaction. The store checker operation processing unit 610 performs reflection of a gift card, etc., reflection of a coupon, or the like on the basis of an operation by the store checker. The reflection of the coupon includes reflection of a discount and the like.

The store checker operation processing unit 610 detects the store checker's touch operation on a settlement button or the like. The store checker operation processing unit 610 shifts to settlement processing on the basis of an operation by the store checker.

The customer operation processing unit 611 acquires information regarding an operation by the customer via the first customer touch panel 25. The customer operation processing unit 611 updates customer operation information on the basis of an operation by the customer.

On the basis of the customer operation information, the mode processing unit 612 changes the payment mode based on selection of a payment method.

The display processing unit 613 displays a customer display image on the first customer touch panel 25 in response to the fact that the reception of the customer operation is started. The display processing unit 613 updates a customer display image on the basis of an operation by the customer. On the basis of an operation by the customer, the display processing unit 613 updates a store checker display image displayed on the first store checker touch panel 23. Hereinafter, “in response to” can also be “on the basis of.”

The settlement processing unit 614 performs the settlement processing on the basis of the transaction data in the one transaction. The settlement processing unit 614 performs the settlement processing in accordance with the payment method selected by the customer in response to the fact that the store checker has input a settlement instruction.

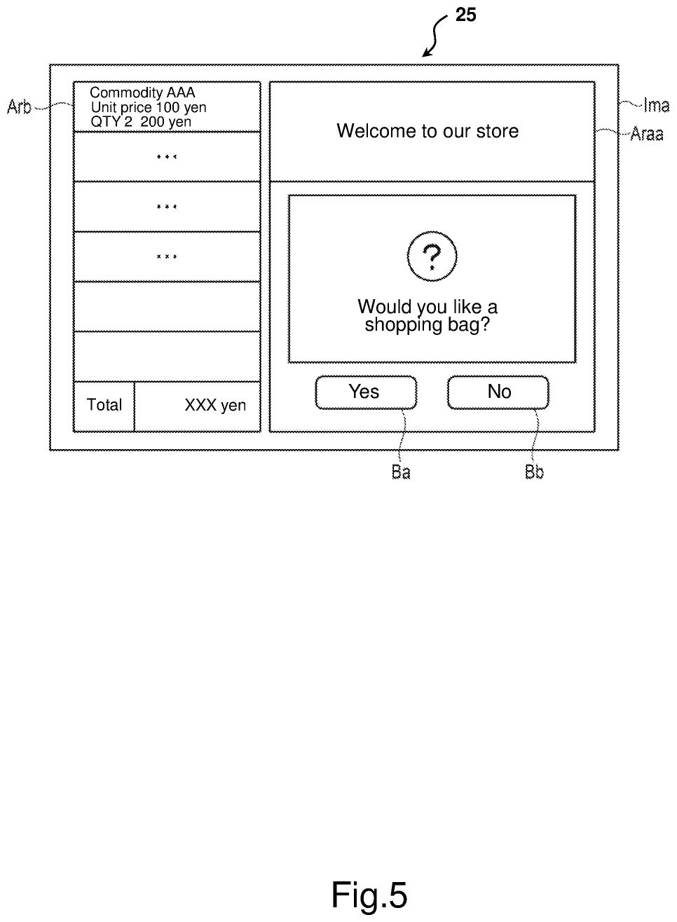

FIG. 5 is an example of the customer display image displayed on the first customer touch panel 25 according to the embodiment. FIG. 5 shows a customer operation image Ima displayed on the first customer touch panel 25 after the customer operation is started. The customer operation image is an example of the customer display image. In the customer operation image Ima, the commodity registration apparatus acquires information based on an operation by the customer as to whether or not to purchase a shopping bag.

The customer operation image Ima includes a customer operation area Araa and a registered commodity display area Arb. The customer operation area Araa includes a guide message for guiding the customer operation, a “Yes” button Ba, and a “No” button Bb. The guide message includes a text message for guiding the operation by the customer. The customer operation image Ima includes a guide message for guiding selection of whether or not to purchase a shopping bag, e.g., “Would you like a shopping bag?” The “Yes” button Ba and the “No” button Bb are software keys. The “Yes” button Ba is an operation element for instructing to purchase a shopping bag. The “No” button Bb is an operation element for instructing not to purchase a shopping bag. The registered commodity display area Arb is an area displaying a list of registered commodities. The list of registered commodities includes a list showing commodity names, purchase quantities, unit prices, sales amounts, etc. of purchase commodities in one transaction in numerical order. The list of registered commodities includes the sum of the purchase quantities of the purchase commodities in the one transaction. The registered commodity display area Arb can be updated on the basis of a commodity registration operation by the store checker.

For example, the customer performs an operation to make an input as to whether or not to purchase a shopping bag in accordance with the customer operation image Ima displayed on the first customer touch panel 25. The customer selecting the “Yes” button Ba is an example of specifying shift to the next processing in a case where the customer will purchase a shopping bag. The customer operation processing unit 611 determines that an operation regarding the selection of whether or not to purchase a shopping bag has been confirmed in response to the fact that the customer has selected the “No” button Bb.

It should be noted that the commodity registration apparatus may output the guide message by a voice or a moving image. In this case, the commodity registration apparatus may output the voice by controlling a loudspeaker (not shown). The loudspeaker may be built in the commodity registration apparatus or may be externally connected to the commodity registration apparatus.

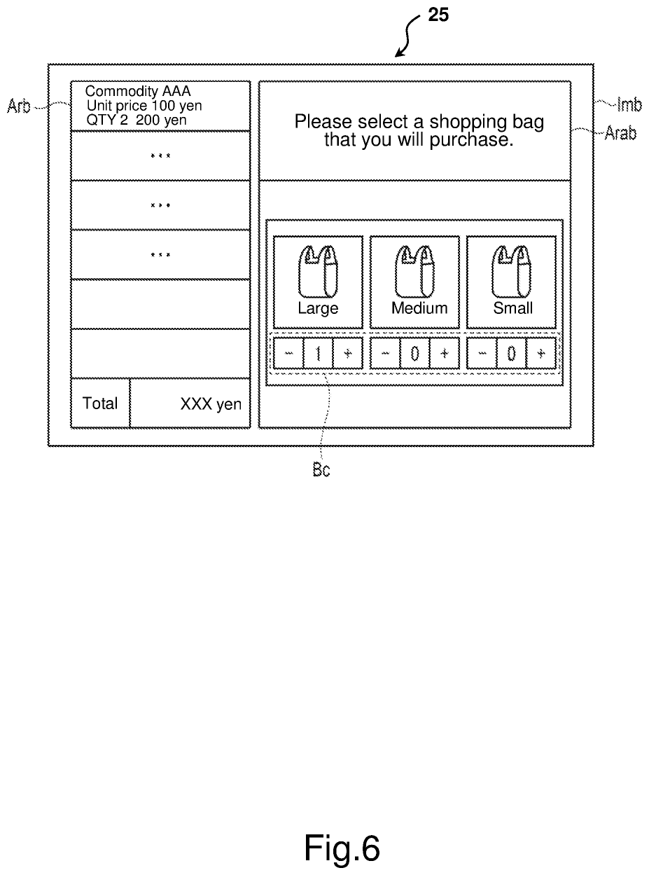

FIG. 6 is an example of the customer display image displayed on the first customer touch panel 25 according to the embodiment. FIG. 6 shows a customer operation image Imb displayed on the first customer touch panel 25 in a case where the customer has selected the “Yes” button Ba by a touch operation or the like in the customer operation image Ima. The display processing unit 613 shifts the customer display image from the customer operation image Ima to the customer operation image Imb in response to an operation by the customer for an input indicating that the customer has selected to purchase a shopping bag. In the customer operation image Imb, the commodity registration apparatus acquires information based on an operation by the customer as to size and number of shopping bags to be purchased.

The customer operation image Imb includes a customer operation area Arab and the registered commodity display area Arb. The customer operation area Arab includes a guide message and a quantity selection button Bc that allows selection of a quantity for each shopping bag size. The customer operation image Imb includes a guide message for guiding selection of the size and number of shopping bags, e.g., “Select a shopping bag that you will purchase.” The quantity selection button Bc is a software key. The quantity selection button Bc is an operation element for instructing to select the number of shopping bags for each shopping bag size.

For example, the customer selects a plus or minus button for each size of shopping bag(s) that the customer wishes to purchase, thereby selecting the size and number of shopping bags. The customer performs an operation of selecting and inputting the size and number of shopping bags in accordance with the customer operation image Imb displayed on the first customer touch panel 25. It should be noted that the display processing unit 613 may shift the image of the customer operation area from the image of the customer operation area Araa to the image of the customer operation area Arab in response to the fact that the customer has selected to purchase a shopping bag. It should be noted that the commodity registration apparatus may output the guide message by a voice or a moving image.

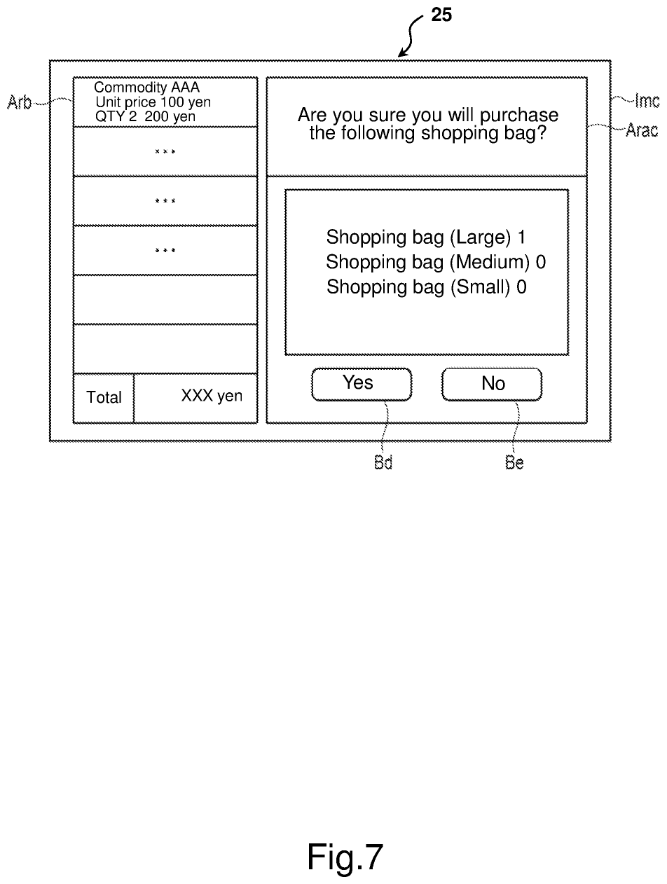

FIG. 7 is an example of the customer display image displayed on the first customer touch panel 25 according to the embodiment. FIG. 7 shows a customer operation image Imc displayed on the first customer touch panel 25 in a case where the customer has selected the size and number of shopping bags in the customer operation image Imb. The display processing unit 613 shifts the customer display image from the customer operation image Imb to the customer operation image Imc in response to an operation by the customer for an input indicating that the customer has selected the size and number of shopping bags. In the customer operation image Imc, the commodity registration apparatus acquires information based on an operation by the customer as to confirmation of the selection of whether or not to purchase a shopping bag.

The customer operation image Imc includes a customer operation area Arac and the registered commodity display area Arb. The customer operation area Arac includes a guide message, a “Yes” button Bd, and a “No” button Be. The customer operation image Imc includes a guide message for prompting the customer to confirm the selection of whether or not to purchase a shopping bag, e.g., “Are you sure you will purchase the following shopping bag?” The “Yes” button Bd and the “No” button Be are software keys. The “Yes” button Bd is an operation element for instructing to confirm the selection of whether or not to purchase a shopping bag. The customer operation processing unit 611 determines that the operation regarding the selection of whether or not to purchase a shopping bag has been confirmed in response to the fact that the customer has selected the “Yes” button Bd. The “No” button Be is an operation element for instructing not to confirm the selection of whether or not to purchase a shopping bag. The “No” button Be may be an operation element for instructing to shift the customer display image from the customer operation image Imc to the customer operation image Imb.

For example, the customer selects the “Yes” button Bd by a touch operation or the like in a case of confirming the size and number of shopping bags that the customer wishes to purchase. The customer selects the “No” button Be by a touch operation or the like in a case of modifying the size and number of shopping bags that the customer wishes to purchase. In this case, the customer modifies the size and number of shopping bags in the customer operation image Imb. It should be noted that the display processing unit 613 may shift the image of the customer operation area from the image of the customer operation area Arab to the image of the customer operation area Arac in response to the fact that the customer has selected to purchase a shopping bag. It should be noted that the commodity registration apparatus may output the guide message by a voice or a moving image.

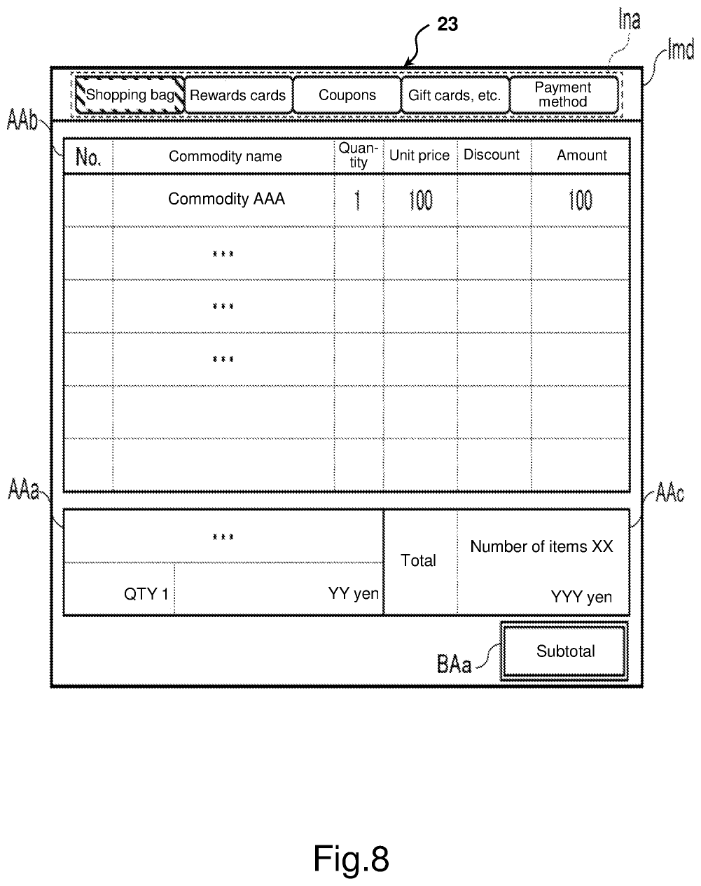

FIG. 8 is an example of the store checker display image displayed on the first store checker touch panel 23 according to the embodiment. FIG. 8 shows a store checker display image Imd displayed on the first store checker touch panel 23 when the customer operation is started. The store checker display image Imd denotes a store checker display image in a case where the customer has selected to purchase a shopping bag.

The store checker display image Imd includes a current area AAa, a statement area AAb, and a total area AAc. The current area AAa is an area displaying a commodity name, a purchase quantity, and a sales amount of the latest purchase commodity. The statement area AAb is an area displaying commodity names, purchase quantities, unit prices, discount amounts, and sales amounts of the purchase commodities in the one transaction in numerical order as a list. The total area AAc is an area displaying the sum of the purchase quantities of the purchase commodities in the one transaction and the sum of the sales amounts. The store checker display image Imd includes a subtotal button BAa. The subtotal button BAa is a software key. The subtotal button BAa is an operation element for commanding output of a subtotal of the purchase commodities registered as the one transaction. The subtotal button BAa is an operation element for commanding application of operation information of the customer operation to the transaction data in the one transaction. The store checker display image Imd includes an indicator Ina indicating a progress status of the customer operation. The indicator Ina displays a status for each customer operation item. The indicator Ina includes, for example, a status regarding the selection of whether or not to purchase a shopping bag, the entry of rewards cards, the entry of coupons, the entry of gift cards, etc., and the selection of a payment method. The indicator Ina can display a status for each customer operation item in order of operations by the customer. The indicator Ina displays a status for each customer operation item in a distinctive manner depending on the status. For example, the indicator Ina may display an operation start status, an operating status, an operation end status, and an intervention-required status in different display manners. The display manners include, for example, letters decorations such as letters color, size, font, circled letters, and letters brightness or luminance, background color, background brightness or luminance, background patterns, frame color, and blinking display.

For example, an indicator associated with the selection of whether or not to purchase a shopping bag may be displayed in yellow in the indicator Ina in a case where the customer has started the selection of whether or not to purchase a shopping bag. The indicator associated with the selection of whether or not to purchase a shopping bag may be displayed in grey in the indicator Ina in a case where the customer has confirmed the selection of whether or not to purchase a shopping bag. In the indicator Ina, indicators associated with the items not operated by the customer may be displayed in a display manner indicating that these are not operated. In this case, indicators other than the indicator associated with the selection of whether or not to purchase a shopping bag may be displayed in white in the indicator Ina.

In accordance with this example, the store checker can visually recognize the progress status of the item operated by the customer through the indicator Ina.

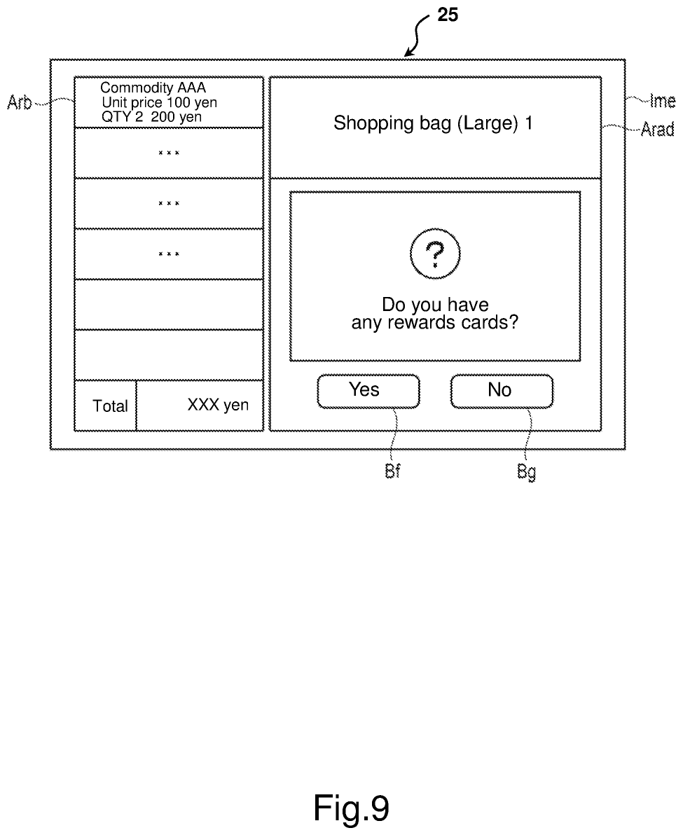

FIG. 9 is an example of the customer display image displayed on the first customer touch panel 25 according to the embodiment. FIG. 9 shows a customer operation image Ime displayed on the first customer touch panel 25 in a case where the customer has selected the “Yes” button Bd by a touch operation or the like in the customer operation image Imc (FIG. 7). The display processing unit 613 shifts the customer display image from the customer operation image Imc to the customer operation image Ime in response to an operation by the customer for an input indicating the confirmation of the shopping bag. In the customer operation image Ime, the commodity registration apparatus acquires information based on an operation by the customer as to whether or not the customer has a rewards card. It should be noted that the customer operation image Ime may be displayed on the first customer touch panel 25 in a case where the customer has selected the “No” button Bb in the customer operation image Ima by a touch operation or the like. The display processing unit 613 shifts the customer display image from the customer operation image Ima to the customer operation image Ime in response to an operation by the customer for an input indicating the confirmation as to whether or not to purchase a shopping bag.

The customer operation image Ime includes a customer operation area Arad and the registered commodity display area Arb. The customer operation area Arad includes a guide message, a “Yes” button Bf, and a “No” button Bg. The customer operation image Ime includes a guide message for guiding selection of whether or not the customer has a rewards card, e.g., “Do you have any rewards cards?” The “Yes” button Bf and the “No” button Bg are software keys. The “Yes” button Bf is an operation element for specifying that the customer has a rewards card. The “No” button Bg is an operation element for specifying that the customer does not have a rewards card.

The customer operation area Arad may display operation information regarding the customer operation item operated by the customer. For example, the customer operation area Arad may include text information, e.g., “Shopping bag (Large) 1.”

For example, the customer performs an operation to make an input as to whether or not the customer has a rewards card in accordance with the customer operation image Ime displayed on the first customer touch panel 25. The customer selecting the “Yes” button Bf is an example of specifying shift to the next processing in a case where the customer has a rewards card. The customer selecting the “No” button Bg is an example of confirming the operation regarding the entry of rewards cards. The customer operation processing unit 611 determines that the operation regarding the entry of rewards cards has been confirmed in response to the fact that the customer has selected the “No” button Bg. It should be noted that the display processing unit 613 may shift the image of the customer operation area to the image of the customer operation area Arad in response to the fact that the customer has confirmed the shopping bag. It should be noted that the commodity registration apparatus may output the guide message by a voice or a moving image.

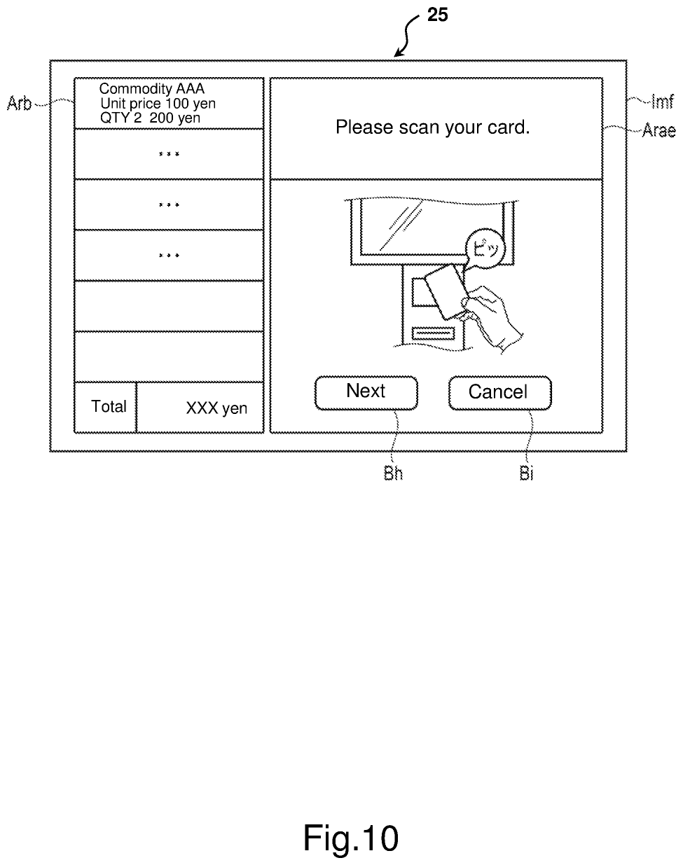

FIG. 10 is an example of the customer display image displayed on the first customer touch panel 25 according to the embodiment. FIG. 10 shows a customer operation image Imf displayed on the first customer touch panel 25 in a case where the customer has selected the “Yes” button Bf by a touch operation or the like in the customer operation image Ime (FIG. 9). The display processing unit 613 shifts the customer display image from the customer operation image Ime to the customer operation image Imf in response to an operation by the customer for an input indicating that the customer has specified that the customer has a rewards card.

The customer operation image Imf includes a customer operation area Arae and the registered commodity display area Arb. The customer operation area Arae includes a guide message, a “Next” button Bh, and a “Cancel” button Bi. The customer operation image Imf includes a guide message for prompting the customer to scan the rewards card, e.g., “Scan your card.” The “Next” button Bh and the “Cancel” button Bi are software keys. The “Next” button Bh is an operation element for instructing to complete scanning of the rewards card. The “Next” button Bh is an example of confirming the operation regarding the entry of rewards cards. The customer operation processing unit 611 determines that the operation regarding the entry of rewards cards has been confirmed in response to the fact that the customer has selected the “Next” button Bh. The “Cancel” button Bi is an operation element for instructing to cancel scanning of the rewards card. The “Cancel” button Bi may be an operation element for instructing to shift the customer display image from the customer operation image Imf to the customer operation image Ime. It should be noted that the “Next” button does not need to be provided. In this case, the processing may shift to the next step by scanning the rewards card.

For example, the customer scans the rewards card with the customer scanner 26 or the like. After scanning the rewards card, the customer selects the “Next” button Bh by a touch operation or the like. In order to cancel scanning of the rewards card, the customer selects the “Cancel” button Bi by a touch operation or the like. It should be noted that the display processing unit 613 may shift the image of the customer operation area from the image of the customer operation area Arad to the image of the customer operation area Arae in response to the fact that the customer has specified that the customer has a rewards card. It should be noted that the commodity registration apparatus may output the guide message by a voice or a moving image.

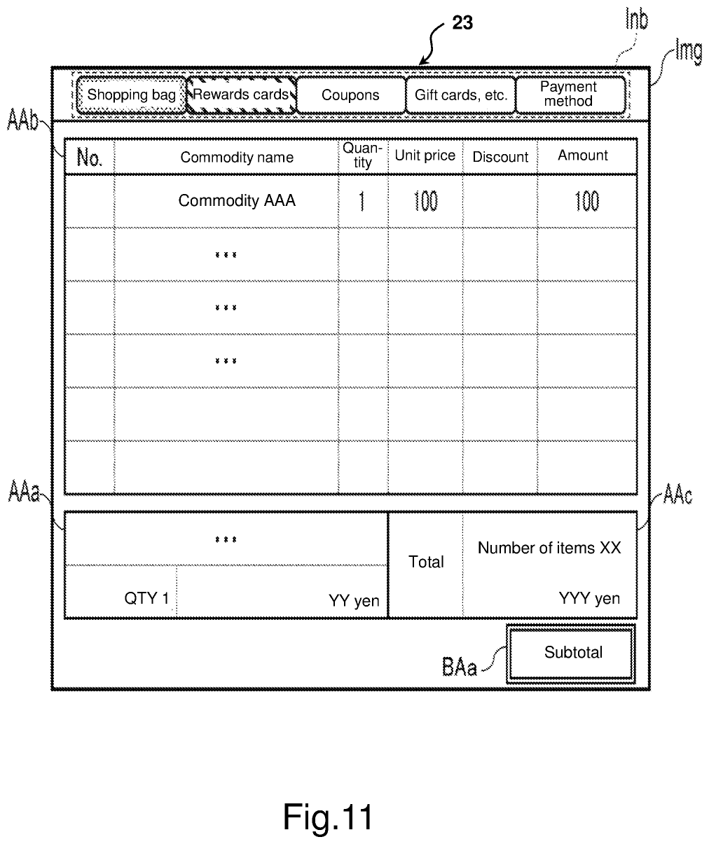

FIG. 11 is an example of the store checker display image displayed on the first store checker touch panel 23 according to the embodiment. FIG. 11 shows a store checker display image Img displayed on the first store checker touch panel 23 when the customer operation is started. The store checker display image Img denotes a store checker display image in a case where the customer has completed the entry of rewards cards.

The store checker display image Img includes the current area AAa, the statement area AAb, and the total area AAc. The store checker display image Img includes the subtotal button BAa.

The store checker display image Img includes an indicator Inb indicating a progress status of the customer operation. The indicator Inb displays a status for each customer operation item as in the indicator Ina.

For example, an indicator associated with the entry of rewards cards may be displayed in yellow in the indicator Inb in a case where the customer has started the entry of rewards cards. The indicator associated with the entry of rewards cards may be displayed in grey in the indicator Inb in a case where the customer has confirmed the entry of rewards cards. In the indicator Inb, indicators associated with the items not operated by the customer may be displayed in a display manner indicating that these are not operated.

For example, a case where the customer has completed the operation regarding the selection of whether or not to purchase a shopping bag and the entry of rewards cards is in progress will be described. In the indicator Inb, the indicator associated with the selection of whether or not to purchase a shopping bag may be displayed in grey or the indicator associated with the entry of rewards cards may be displayed in yellow. In the indicator Inb, indicators other than the indicator associated with the selection of whether or not to purchase a shopping bag and the indicator associated with the entry of rewards cards may be displayed in white.

In accordance with this example, the store checker can visually recognize the progress status of the item operated by the customer through the indicator Inb.

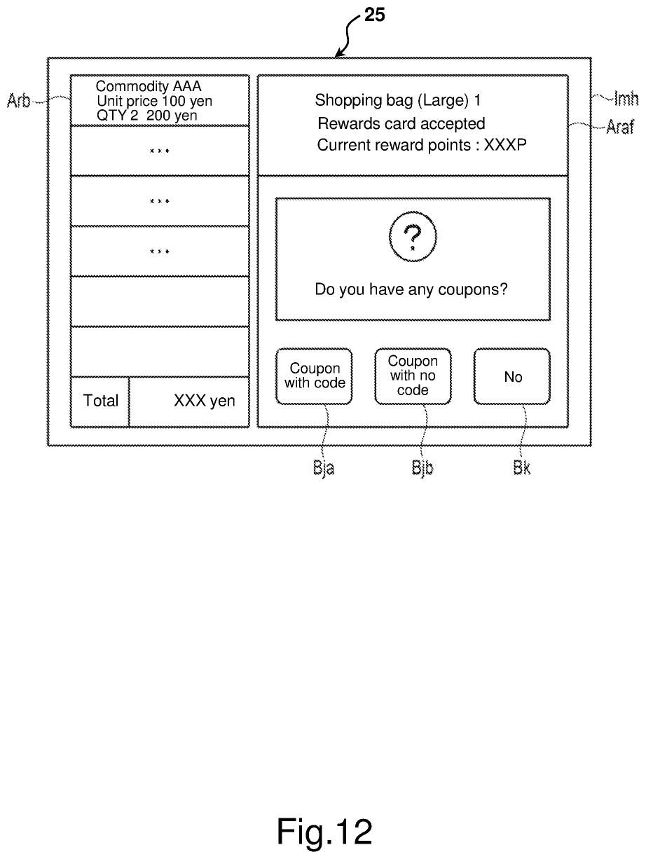

FIG. 12 is an example of the customer display image displayed on the first customer touch panel 25 according to the embodiment. FIG. 12 shows a customer operation image Imh displayed on the first customer touch panel 25 in a case where the customer has selected the “Next” button Bh by a touch operation or the like in the customer operation image Imf. The display processing unit 613 shifts the customer display image from the customer operation image Imf to the customer operation image Imh in response to an operation by the customer for an input indicating the confirmation of the entry of rewards cards. In the customer operation image Imh, the commodity registration apparatus acquires information based on an operation by the customer as to the entry of coupons. It should be noted that the customer operation image Imh may be displayed on the first customer touch panel 25 in a case where the customer has selected the “No” button Bg by a touch operation or the like in the customer operation image Ime.

The customer operation image Imh includes a customer operation area Araf and the registered commodity display area Arb. The customer operation area Araf includes a guide message, a “coupon with code” button Bja, a “coupon with no code” button Bjb, and a “No” button Bk. The customer operation image Imh includes a guide message for guiding selection of whether or not the customer has a coupon, e.g., “Do you have any coupons?” The “coupon with code” button Bja, the “coupon with no code” button Bjb, and the “No” button Bk are software keys. The “coupon with code” button Bja and the “coupon with no code” button Bjb are operation elements for specifying that the customer has a coupon. The “No” button Bk is an operation element for specifying that the customer does not have a coupon.

The customer operation area Araf may display operation information regarding the customer operation item operated by the customer. For example, the customer operation area Araf may include text information, e.g., “Shopping bag (Large) 1, Rewards card accepted, Current reward points: XX points.”

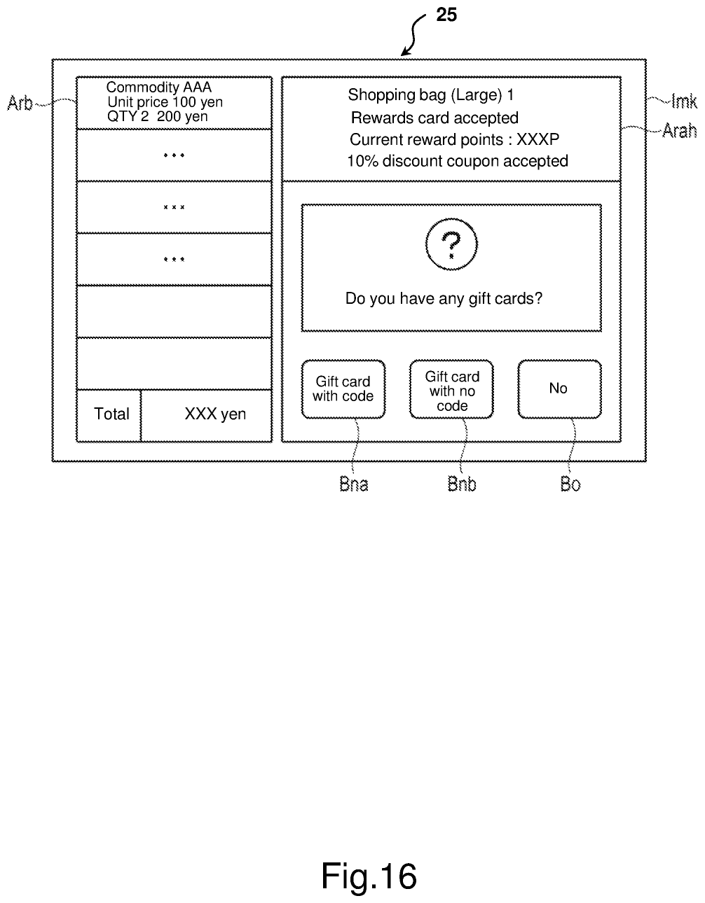

For example, the customer performs an operation to make an input as to whether or not the customer has a coupon in accordance with the customer operation image Imh displayed on the first customer touch panel 25. In a case where the customer has a coupon, the customer selects the “coupon with code” button Bja or the “coupon with no code” button Bjb. The customer selecting the “coupon with code” button Bja or the “coupon with no code” button Bjb is an example of specifying shift to the next processing in a case where the customer has a coupon. The customer selecting the “No” button Bk is an example of confirming the operation regarding the entry of coupons. It should be noted that the display processing unit 613 may shift the image of the customer operation area to the image of the customer operation area Araf in response to the fact that the customer has confirmed the entry of rewards cards. It should be noted that the commodity registration apparatus may output the guide message by a voice or a moving image. For example, the customer selects the “coupon with no code” button Bjb in a case where the customer has a coupon with no coupon code. In this case, the display processing unit 613 may display a customer operation image including a message, e.g., “Please show your coupon to our staff before check-out.” The display processing unit 613 may display a customer operation image Imk (FIG. 16) regarding the entry of gift cards, etc. It should be noted that in a case where the customer has selected the “coupon with no code” button Bjb, the store checker needs to perform processing of receiving a coupon from the customer. The customer operation processing unit 611 determines that intervention of the store checker is required with respect to the entry of coupons in response to the fact that the customer has selected the “coupon with no code” button Bjb.

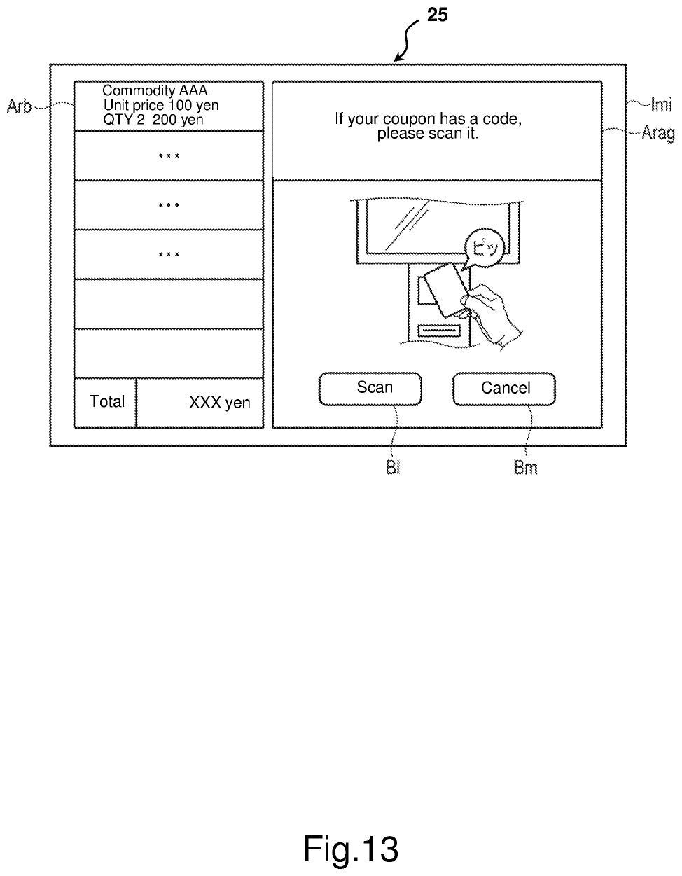

FIG. 13 is an example of the customer display image displayed on the first customer touch panel 25 according to the embodiment. FIG. 13 shows a customer operation image Imi displayed on the first customer touch panel 25 in a case where the customer has selected the “coupon with code” button Bja by a touch operation or the like in the customer operation image Imh. The display processing unit 613 shifts the customer display image from the customer operation image Imh to the customer operation image Imi in response to an operation by the customer for an input indicating that the customer has specified that the customer has a coupon with a code.

The customer operation image Imi includes a customer operation area Arag and the registered commodity display area Arb. The customer operation area Arag includes a guide message, a “Scan” button Bl, and a “Cancel” button Bm. The customer operation image Imi includes a guide message for prompting the customer to scan a coupon code, e.g., “If your coupon has a code, please scan it.” The “Scan” button Bl and the “Cancel” button Bm are software keys. The customer operation processing unit 611 acquires the coupon code in response to the fact that the customer has selected the “Scan” button Bl. A “Cancel” button Bm is an operation element for instructing to cancel the scanning of a coupon code. The “Cancel” button Bm may be an operation element for instructing to shift the customer display image from the customer operation image Imi to the customer operation image Imh.

For example, after the customer has selected the “Scan” button Bl, the customer scans the coupon code with the customer scanner 26 or the like. In order to cancel the scanning of a coupon code, the customer selects the “Cancel” button Bm by a touch operation or the like. It should be noted that the display processing unit 613 may shift the image of the customer operation area to the image of the customer operation area Arag in response to the fact that the customer has specified that the customer has a coupon. It should be noted that the commodity registration apparatus may output the guide message by a voice or a moving image.

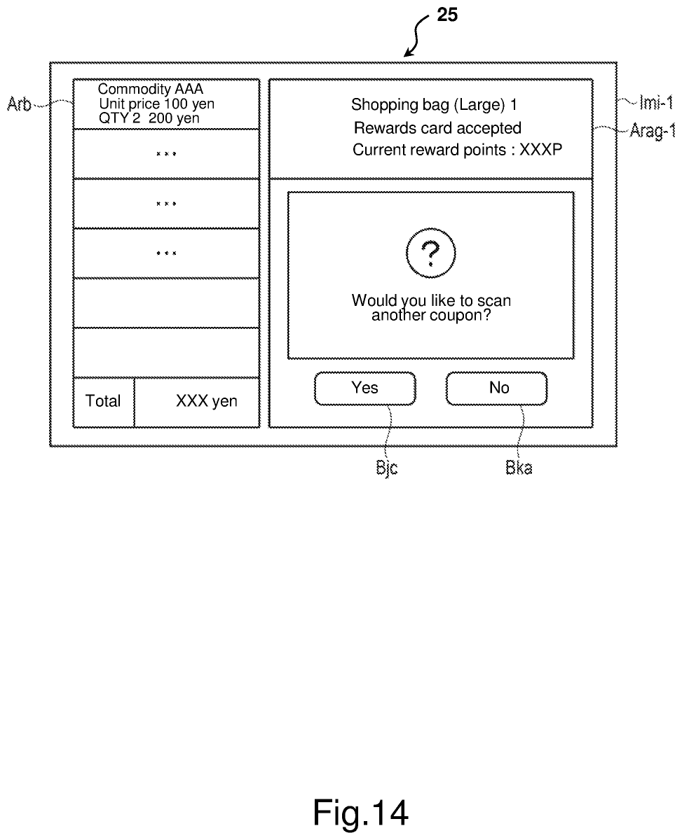

FIG. 14 is an example of the customer display image displayed on the first customer touch panel 25 according to the embodiment. FIG. 14 shows a customer operation image Imi-1 displayed on the first customer touch panel 25 in a case where the customer has selected the “Scan” button Bl by a touch operation or the like in the customer operation image Imi and has performed the operation of scanning the code. The display processing unit 613 shifts the customer display image from the customer operation image Imi to the customer operation image Imi-1 in response to the fact that the customer has performed the operation of scanning the coupon code.

The customer operation image Imi-1 includes a customer operation area Arag-1 and the registered commodity display area Arb. The customer operation area Arag-1 includes a guide message, a “Yes” button Bjc, and a “No” button Bka. The customer operation image Imi-1 includes a guide message for prompting the customer to scan another coupon code, e.g., “Would you like to scan another coupon?” The “Yes” button Bjc and the “No” button Bka are software keys. The display processing unit 613 displays an image for making the customer scan the coupon code in response to the fact that the customer has selected the “Yes” button Bjc. The display processing unit 613 may display an image similar to the customer operation image Imi. The “No” button Bka is an example of confirming the operation regarding the entry of coupons. It should be noted that the commodity registration apparatus may output the guide message by a voice or a moving image. The display processing unit 613 may repeat display of the customer operation image Imi-1 and the customer operation image Imi until the customer selects the “No” button. Accordingly, also in a case where the customer has a plurality of coupons, the customer can perform entry operations for the coupons.

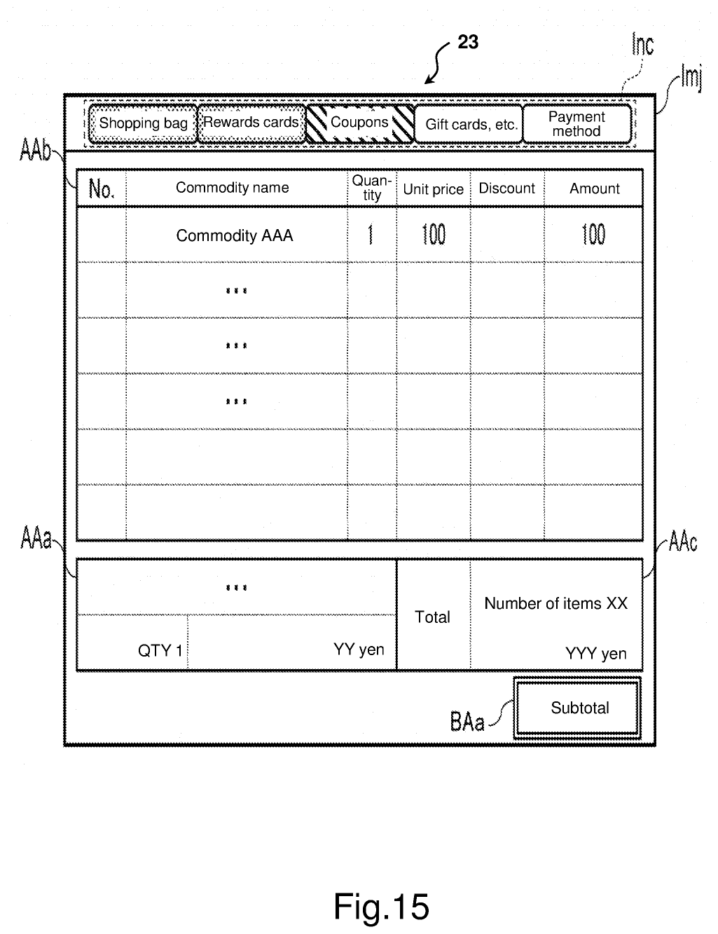

FIG. 15 is an example of the store checker display image displayed on the first store checker touch panel 23 according to the embodiment. FIG. 15 shows a store checker display image Imj displayed on the first store checker touch panel 23 when the customer operation is started. The store checker display image Imj denotes a store checker display image in a case where the customer has completed the entry of coupons.

The store checker display image Imj includes the current area AAa, the statement area AAb, and the total area AAc. The store checker display image Imj includes the subtotal button BAa. The store checker display image Imj includes an indicator Inc indicating a progress status of the customer operation. The indicator Inc displays a status for each customer operation item as in the indicator Ina.

For example, in a case where the customer has started the entry of coupons, an indicator associated with the entry of coupons may be displayed in yellow in the indicator Inc. In a case where the customer has confirmed the entry of coupons, the indicator associated with the entry of coupons may be displayed in grey in the indicator Inc. In a case where the customer has confirmed the entry of coupons without scanning a coupon code after the customer has specified that the customer has a coupon, the customer operation processing unit 611 determines that intervention of the store checker is required with respect to the entry of coupons. In this case, the indicator associated with the entry of coupons may be displayed in red in the indicator Inc. In the indicator Inc, indicators associated with the items not operated by the customer may be displayed in a display manner indicating that these are not operated.

For example, a case where the customer has completed the operation regarding the selection of whether or not to purchase a shopping bag and the entry of rewards cards and the entry of coupons is in progress will be described. In the indicator Inc, the selection of whether or not to purchase a shopping bag, and the indicator associated with the entry of rewards cards may be displayed in grey or the indicator associated with the entry of coupons may be displayed in yellow. In a case where intervention of the store checker is required with respect to the entry of coupons, the indicator associated with the entry of coupons may be displayed in red. In the indicator Inc, indicators other than the indicators associated with the selection of whether or not to purchase a shopping bag, the entry of rewards cards, and the entry of coupons may be displayed in white.

In accordance with this example, the store checker can visually recognize the progress status of the item operated by the customer through the indicator Inc. Moreover, the store checker can visually recognize whether or not there is processing for which intervention of the store checker is required through the indicator Inc.

FIG. 16 is an example of the customer display image displayed on the first customer touch panel 25 according to the embodiment. FIG. 16 shows the customer operation image Imk displayed on the first customer touch panel 25 in a case where the customer has selected the “No” button Bka by a touch operation or the like in the customer operation image Imi-1 or in a case where the processing as to whether or not the customer performs the entry of coupons has ended. The display processing unit 613 shifts the customer display image from the customer operation image Imi to the customer operation image Imk in response to an operation by the customer for an input indicating the confirmation of the entry of coupons. In the customer operation image Imk, the commodity registration apparatus acquires information based on an operation by the customer as to the entry of gift cards, etc. It should be noted that the customer operation image Imk may be displayed on the first customer touch panel 25 in a case where the customer has selected the “No” button Bk by a touch operation or the like in the customer operation image Imh.

The customer operation image Imk includes a customer operation area Arah and the registered commodity display area Arb. The customer operation area Arah includes a guide message, a “gift card with code” button Bna, a “gift card with no code” button Bnb, and a “No” button Bo. The customer operation image Imk includes a guide message for guiding selection of whether or not the customer has a gift card, etc., e.g., “Do you have any gift cards, etc.?” The “gift card with code” button Bna, the “gift card with no code” button Bnb, and the “No” button Bo are software keys. The “gift card with code” button Bna and the “gift card with no code” button Bnb are operation elements for specifying that the customer has a coupon. The “No” button Bo is an operation element for specifying that the customer does not have a coupon.

The customer operation area Arah may display operation information regarding the customer operation item operated by the customer. For example, the customer operation area Arah may include text information, e.g., “Shopping bag (Large) 1, Rewards card accepted, Current reward points: XX points, 10% discount coupon accepted.”

For example, the customer performs an operation to make an input as to whether or not the customer has a gift card, etc. in accordance with the customer operation image Imk displayed on the first customer touch panel 25. The customer selecting the “gift card with code” button Bna, the “gift card with no code” button Bnb, or the “No” button Bo is an example of confirming the operation regarding the entry of gift cards, etc. In a case where the customer has selected the “gift card with no code” button Bnb, the store checker needs to perform processing of receiving a gift card, etc. from the customer. The customer operation processing unit 611 determines that intervention of the store checker is required with respect to the entry of gift cards, etc. in response to the fact that the customer has selected the “gift card with no code” button Bnb. It should be noted that the display processing unit 613 may shift the image of the customer operation area to the image of the customer operation area Arah in response to an operation by the customer for an input indicating that the customer has confirmed the entry of coupons. It should be noted that the commodity registration apparatus may output the guide message by a voice or a moving image.

In a case where the customer has selected the “gift card with code” button Bna, the display processing unit 613 displays a customer operation image for making the customer scan the code with the customer scanner 26 or the like. The customer operation image for making the customer scan the code may be an image similar to the customer operation image Imi regarding the scanning of a coupon code. For scanning a plurality of gift cards, etc. with a code, the display processing unit 613 may display images similar to the customer operation image Imi and the customer operation image Imi-1.

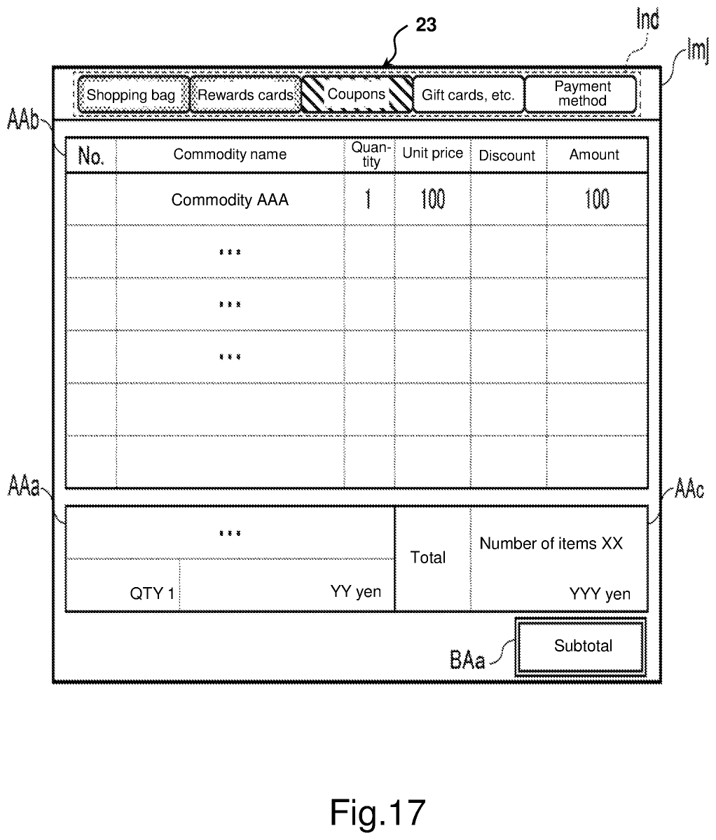

FIG. 17 is an example of the store checker display image displayed on the first store checker touch panel 23 according to the embodiment. FIG. 17 shows a store checker display image Iml displayed on the first store checker touch panel 23 when the customer operation is started. The store checker display image Iml denotes a store checker display image in a case where the customer has completed the entry of gift cards, etc.

The store checker display image Iml includes the current area AAa, the statement area AAb, and the total area AAc. The store checker display image Iml includes the subtotal button BAa. The store checker display image Iml includes an indicator Ind indicating a progress status of the customer operation. The indicator Ind displays a status for each customer operation item as in the indicator Ina.

For example, an indicator associated with the entry of gift cards, etc. may be displayed in yellow in the indicator Ind in a case where the customer has started the entry of gift cards, etc. The indicator associated with the entry of gift cards, etc. may be displayed in grey in the indicator Ind in a case where the customer has confirmed the entry of gift cards, etc. In a case where the customer has specified that the customer has a gift card, etc., the customer operation processing unit 611 determines that intervention of the store checker is required with respect to the entry of gift cards, etc. In this case, the indicator associated with the entry of gift cards, etc. may be displayed in red in the indicator Ind. In the indicator Ind, indicators associated with the items not operated by the customer may be displayed in a display manner indicating that these are not operated.

For example, a case where the customer has completed the operation regarding the selection of whether or not to purchase a shopping bag, the entry of rewards cards, and the entry of coupons and the entry of gift cards, etc. is in progress will be described. In the indicator Ind, the selection of whether or not to purchase a shopping bag, the entry of rewards cards, and the indicator associated with the entry of coupons may be displayed in grey or the indicator associated with the entry of gift cards may be displayed in yellow. An indicator associated with the operation for which intervention of the store checker is required may be displayed in red in the indicator Ind. In a case where intervention of the store checker is required with respect to the entry of gift cards, the indicator associated with the entry of gift cards may be displayed in red in the indicator Ind. In the indicator Ind, an indicator other than the indicators associated with the selection of whether or not to purchase a shopping bag, the entry of rewards cards, the entry of coupons, and the entry of gift cards, etc. may be displayed in white.

In accordance with this example, the store checker can visually recognize the progress status of the item operated by the customer through the indicator Ind. Moreover, the store checker can visually recognize whether or not there is processing for which intervention of the store checker is required through the indicator Ind.

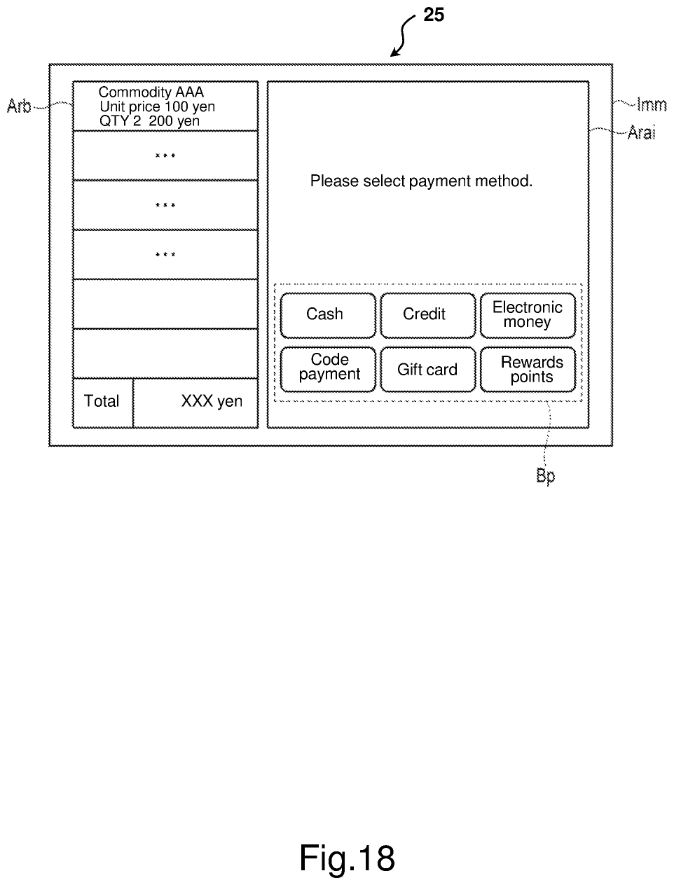

FIG. 18 is an example of the customer display image displayed on the first customer touch panel 25 according to the embodiment. FIG. 18 shows a customer operation image Imm displayed on the first customer touch panel 25 in a case where the customer has selected the “Yes” button Bn or the “No” button Bo by a touch operation or the like in the customer operation image Imk. The display processing unit 613 shifts the customer display image from the customer operation image Imk to the customer operation image Imm in response to an operation by the customer for an input indicating the confirmation of the entry of gift cards, etc. In the customer operation image Imm, the commodity registration apparatus acquires information based on an operation regarding the payment method selection by the customer.

The customer operation image Imm includes a customer operation area Arai and the registered commodity display area Arb. The customer operation area Arai includes a guide message and a selection button group Bp. The guide message includes a text message, e.g., “Please select a payment method.” The selection button group Bp includes a payment method-specifying button for acquiring information regarding the selection of a payment method by the customer. The payment method-specifying button is a software key. The payment method-specifying button is an operation element for specifying a variety of payment methods. The payment method-specifying button includes a cash button, a credit button, an electronic money button, a code settlement button, a gift card button, and a rewards point button. The payment method-specifying button is not limited to those examples.

The customer operation area Arah may display operation information regarding the customer operation item operated by the customer.

For example, the customer performs an operation of selecting a payment method in accordance with the customer operation image Imm displayed on the first customer touch panel 25. The customer selecting the payment method-specifying button is an example of confirming the operation regarding the selection of a payment method. In a case where the customer has selected a “gift card button”, the store checker needs to perform processing of receiving a gift card from the customer. The customer operation processing unit 611 determines that intervention of the store checker is required with respect to the selection of a payment method in response to the fact that the customer has selected the “gift card button.” It should be noted that the display processing unit 613 may shift the image of the customer operation area to the image of the customer operation area Arai in response to an operation by the customer for an input indicating that the customer has confirmed the entry of gift cards, etc. It should be noted that the commodity registration apparatus may output the guide message by a voice or a moving image.

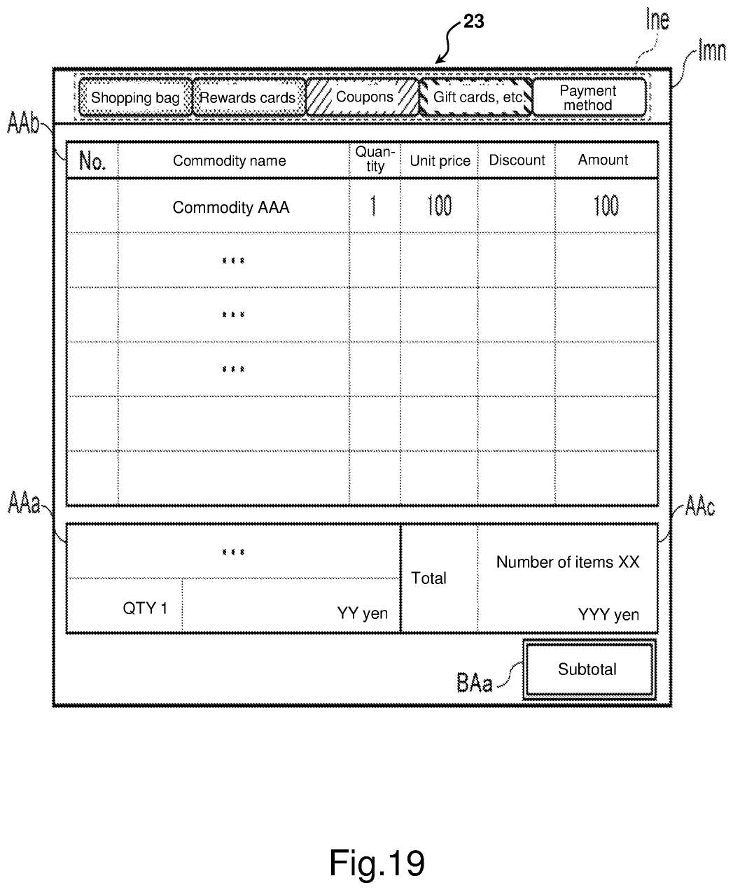

FIG. 19 is an example of the store checker display image displayed on the first store checker touch panel 23 according to the embodiment. FIG. 19 shows a store checker display image Imn displayed on the first store checker touch panel 23 when the customer operation is started. The store checker display image Imn denotes a store checker display image in a case where the customer has selected a payment method.

The store checker display image Imn includes the current area AAa, the statement area AAb, and the total area AAc. The store checker display image Imn includes the subtotal button BAa. The store checker display image Imn includes an indicator Ine indicating a progress status of the customer operation. The indicator Ine displays a status for each customer operation item as in the indicator Ina.

For example, an indicator associated with the selection of a payment method may be displayed in yellow in the indicator Ine in a case where the customer has started the selection of a payment method. The indicator associated with the selection of a payment method may be displayed in grey in the indicator Ine in a case where the customer has confirmed the selection of a payment method. The indicator associated with the selection of a payment method may be displayed in red in the indicator Ine in a case where it is determined that intervention of the store checker is required with respect to the selection of a payment method.

For example, a case where the customer has completed the selection of whether or not to purchase a shopping bag, the entry of rewards cards, the entry of coupons, and the operation regarding the entry of gift cards, etc. and the selection of a payment method is in progress will be described. An indicator associated with the completed operation may be displayed in grey or the indicator associated with the selection of a payment method in progress may be displayed in yellow in the indicator Ine. The indicator associated with the operation for which intervention of the store checker is required may be displayed in red in the indicator Ine. The indicator associated with the selection of a payment method may be displayed in red in the indicator Ind in a case where intervention of the store checker is required with respect to the selection of a payment method. In the indicator Ind, the indicator other than the indicators associated with the selection of whether or not to purchase a shopping bag, the entry of rewards cards, the entry of coupons, and the entry of gift cards, etc. may be displayed in white.

In accordance with this example, the store checker can visually recognize the progress status of the item operated by the customer through the indicator Ind. Moreover, the store checker can visually recognize whether or not there is processing for which intervention of the store checker is required through the indicator Ind.

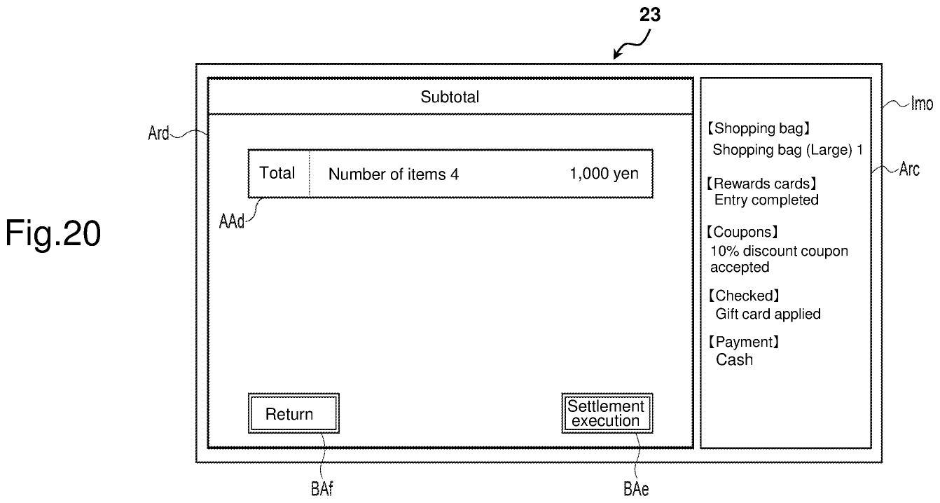

FIG. 20 is an example of the store checker display image displayed on the first store checker touch panel 23 according to the embodiment. FIG. 20 shows a store checker display image Imo displayed on the first store checker touch panel 23 when the store checker has selected and entered the subtotal button Baa in the store checker display image.

The store checker display image Imo includes a customer operation list display area Arc and a subtotal area Ard. The customer operation list display area Arc includes a customer operation list of information regarding the customer operation. The customer operation list includes operation information for each customer operation item.

The subtotal area Ard includes a total area AAd where the sum of the purchase quantities of the purchase commodities and the sum of the sales amounts in the one transaction are displayed. The store checker display image Imo includes a settlement execution button BAe and a return button BAf. The settlement execution button BAe and the return button BAf are software keys. The settlement execution button BAe is an operation element for commanding settlement execution in accordance with the payment method selected by the customer. The return button BAf is an operation element for commanding return to the purchase commodity registration.

In accordance with this example, the store checker can visually recognize the operation information for each customer operation item through the customer operation list. Moreover, the store checker can visually recognize whether or not there is processing for which intervention of the store checker is required through the customer operation list.

### Operation Example

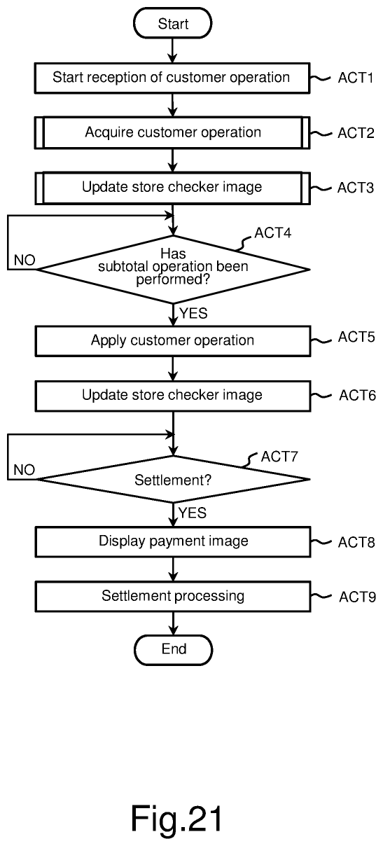

A processing procedure by the commodity sales system 1 will be described. It should be noted that although the subject is the commodity registration apparatus hereinafter, the processor 61 may replace the commodity registration apparatus. It should be noted that the processing procedure described below is merely an example, and each process may be modified if possible. Moreover, as to the processing procedure described below, the step(s) may be omitted, substituted, and added as appropriate depending on an embodiment. FIG. 21 is a flowchart showing an example of an information processing procedure by the commodity registration apparatus according to the embodiment. In the following example, it is assumed that the reception of the customer operation is started on the basis of the store checker's operation via the first store checker touch panel 23. It should be noted that the reception of the customer operation may be started on the basis of the fact that the store checker has started the commodity registration operation. It should be noted that in a case where the store checker does not need to receive the customer operation while performing the commodity registration, for example, in a case where the quantity of commodities purchased by the customer is small, the store checker does not need to perform the operation for starting the reception of the customer operation. In this case, the store checker may perform an operation corresponding to the customer operation.

Hereinafter, the subject is each block realized by the processor 61. However, the processor 61 may replace each block. In ACT 1, the store checker operation processing unit 610 starts the reception of the customer operation on the basis of the operation by the store checker. For example, the store checker operation processing unit 610 acquires a customer operation reception start instruction on the basis of the store checker's touch operation on the customer operation reception start button or the like. On the basis of the fact that the store checker operation processing unit 610 has performed the customer operation reception start instruction, the display processing unit 613 displays the customer operation image on the first customer touch panel 25.

In ACT 2, the customer operation processing unit 611 acquires information based on an operation by the customer. For example, the customer operation processing unit 611 acquires the customer operation information based on a customer operation for each customer operation item via the first customer touch panel 25. The customer operation processing unit 611 stores the customer operation information for each customer operation item in the customer operation information storage area 82 of the main memory 62.

In ACT 3, the display processing unit 613 updates the store checker image on the basis of the customer operation information. For example, the display processing unit 613 updates the store checker image displayed on the first store checker touch panel 23 on the basis of the fact that the customer operation information has been updated. The display processing unit 613 displays a status denoting the progress status of the customer operation in a distinctive manner in accordance with the progress status on the first store checker touch panel 23.

In ACT 4, the store checker operation processing unit 610 determines whether or not a subtotal operation by the store checker has been performed. For example, the store checker operation processing unit 610 determines whether or not the store checker's touch operation on the subtotal button or the like has been detected. In a case where the store checker operation processing unit 610 determines that the subtotal operation has been performed (ACT 4: YES), the processing shifts from ACT 4 to ACT 5. In a case where the store checker operation processing unit 610 determines that the subtotal operation has not been performed (ACT 4: NO), the processing repeats ACT 4.

In ACT 5, the store checker operation processing unit 610 applies the customer operation on the basis of the fact that the subtotal operation by the store checker has been performed. For example, the store checker operation processing unit 610 refers to the customer operation information and applies the customer operation to the transaction data in the one transaction. The store checker operation processing unit 610 applies the operation information for each customer operation item to the transaction data. The store checker operation processing unit 610 changes a total amount of money on the basis of the operation information. For example, the store checker operation processing unit 610 changes the total amount of money in accordance with the size and number of shopping bags on the basis of operation information regarding shopping bag purchase selection. The store checker operation processing unit 610 applies a discount to the total amount of money on the basis of operation information regarding the entry of coupons. In a case where there is an operation for which the intervention by the store checker is required, the store checker operation processing unit 610 receives an intervention operation by the store checker. For example, a case where the customer has a coupon with no coupon code will be described. The store checker receives the coupon from the customer and inputs a discount amount with a ten key of the keyboard 24 in accordance with the coupon. The store checker operation processing unit 610 applies a discount to the total amount of money on the basis of the store checker's input.

In ACT 6, the display processing unit 613 updates the store checker image on the basis of the processing by the store checker operation processing unit 610. For example, the display processing unit 613 displays the total amount of money to which the customer operation information has been applied on the first store checker touch panel 23. The display processing unit 613 displays the total amount of money to which the store checker's operation has been applied on the first store checker touch panel 23 in a case where there is an operation for which the intervention by the store checker is required. The display processing unit 613 may display the customer operation list on the first store checker touch panel 23. The customer operation list is an example of the list display of the customer operations.

In ACT 7, the store checker operation processing unit 610 determines whether or not the store checker's operation for the settlement execution has been performed. For example, the store checker operation processing unit 610 determines whether or not the store checker's touch operation on the settlement execution button or the like has been detected. In a case where the store checker operation processing unit determines that the operation for the settlement execution has been performed (ACT 7: YES), the processing shifts from ACT 7 to ACT 8. In a case where the store checker operation processing unit 610 determines that the subtotal operation has not been performed (ACT 7: NO), the processing repeats ACT 7.

In a case where the store checker operation processing unit 610 determines that the operation for the settlement execution has been performed, the mode processing unit 612 changes the payment mode based on selection of a payment method on the basis of the customer operation information.

In ACT 8, the display processing unit 613 updates the store checker image on the basis of the processing by the mode processing unit 612. For example, the display processing unit 613 displays a payment image on the first store checker touch panel 23.

In ACT 9, the settlement processing unit 614 performs settlement processing on the basis of the transaction data in the one transaction. For example, the settlement processing unit 614 performs the settlement processing by a publicly known settlement processing method.

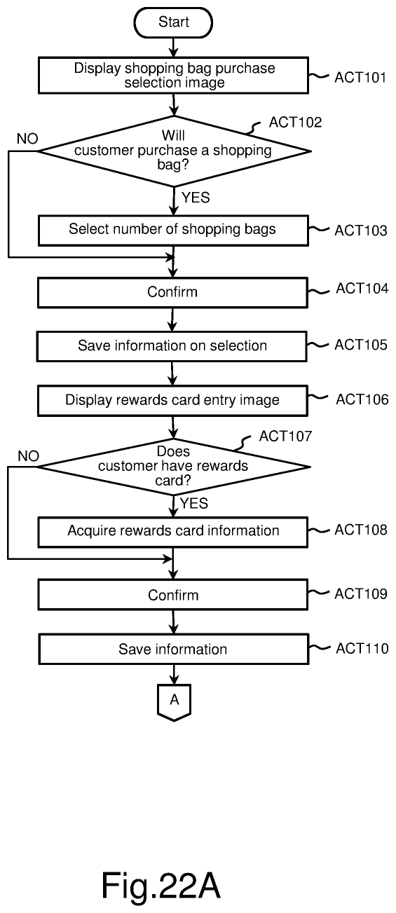

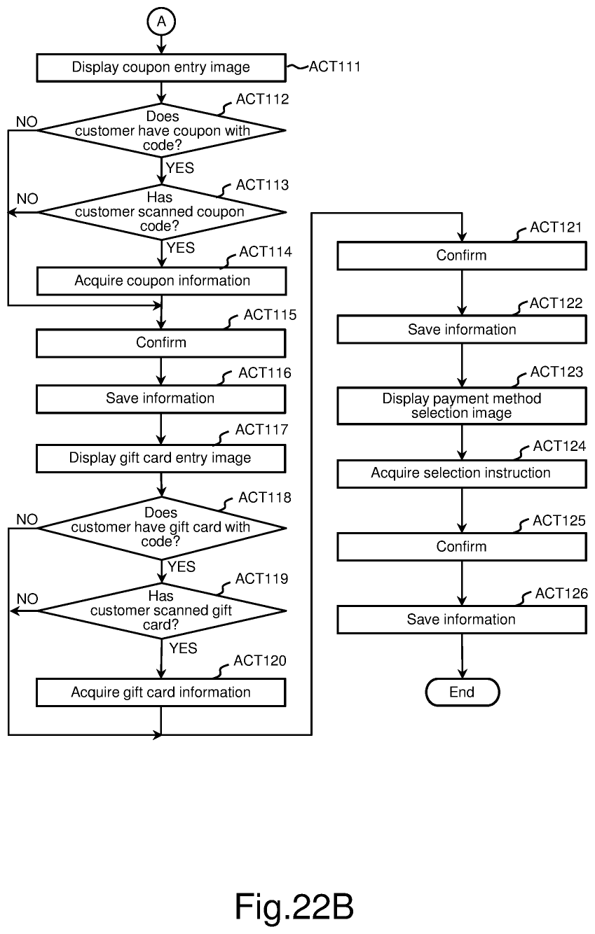

FIGS. 22A and 22B are flowcharts showing an example of the information processing procedure by the commodity registration apparatus according to the embodiment. FIGS. 22A and 22B are an example of the processing procedure acquires information based on the customer operation in ACT 2 in FIG. 21.

In the following example, it is assumed that the customer performs an operation on the basis of the customer display image displayed on the first customer touch panel 25.

In ACT 101, the display processing unit 613 displays, on the first customer touch panel 25, a shopping bag purchase selection image in which the customer selects whether or not to purchase a shopping bag. For example, the display processing unit 613 displays the shopping bag purchase selection image on the first customer touch panel 25 on the basis of a customer operation reception start instruction by the store checker in ACT 1 in FIG. 21. The shopping bag purchase selection image is, for example, the customer operation image Ima shown in FIG. 5. With respect to the operation regarding the selection of whether or not to purchase a shopping bag, the customer operation processing unit 611 changes the status to the operating status.

In ACT 102, the customer operation processing unit 611 determines whether or not an instruction to purchase a shopping bag has been acquired from the customer. For example, on the basis of the fact that an operation on the “Yes” button Ba in the customer operation image Ima has been detected, the customer operation processing unit 611 determines that the instruction to purchase a shopping bag has been acquired. On the basis of the fact that an operation on the “No” button Bb in the customer operation image Ima has been detected, the customer operation processing unit 611 determines that an instruction not to purchase a shopping bag has been acquired. In a case where the customer operation processing unit 611 determines that the instruction to purchase a shopping bag has been acquired (ACT 102: YES), the processing shifts from ACT 102 to ACT 103. In this case, the display processing unit 613 displays the customer operation image Imb shown in FIG. 6 on the first customer touch panel 25. In a case where the customer operation processing unit 611 determines that the instruction not to purchase a shopping bag has been acquired (ACT 102: NO), the processing shifts from ACT 102 to ACT 104.

In ACT 103, the customer operation processing unit 611 acquires an instruction to specify the size and number of shopping bags on the basis of an operation by the customer. In ACT 103, for example, the customer operation processing unit 611 detects a quantity input for each shopping bag size in the customer operation image Imb. The customer operation processing unit 611 acquires size and number of shopping bags to be purchased on the basis of the customer's operation for the input. On the basis of the fact that the instruction to specify the size and number of shopping bags has been acquired, the display processing unit 613 displays the customer operation image Imc shown in FIG. 7 on the first customer touch panel 25.

In ACT 104, the customer operation processing unit 611 confirms the operation regarding the selection of whether or not to purchase a shopping bag on the basis of an operation by the customer. For example, the customer operation processing unit 611 confirms the operation regarding the selection of whether or not to purchase a shopping bag on the basis of the fact that an operation on the “Yes” button Bd in the customer operation image Imc has been detected. In this case, the customer operation processing unit 611 determines that the customer will purchase a shopping bag and also determines the size and number of shopping bags to be purchased with respect to the operation regarding the selection of whether or not to purchase a shopping bag. The customer operation processing unit 611 changes the status to the operation end status with respect to the operation regarding the selection of whether or not to purchase a shopping bag. On the basis of the fact that a touch operation on the “No” button Bb in the customer operation image Ima has been detected in ACT 102, the customer operation processing unit 611 confirms the operation regarding the selection of whether or not to purchase a shopping bag. In this case, the customer operation processing unit 611 determines that the customer will not purchase a shopping bag with respect to the operation regarding the selection of whether or not to purchase a shopping bag. The customer operation processing unit 611 changes the status to the operation end status with respect to the operation regarding the selection of whether or not to purchase a shopping bag.

In ACT 105, the customer operation processing unit 611 saves operation information regarding the confirmed selection of whether or not to purchase a shopping bag information. For example, the customer operation processing unit 611 saves the operation information with respect to the operation regarding the selection of whether or not to purchase a shopping bag confirmed in ACT 104 in the customer operation information storage area 82 of the main memory 62.

In ACT 106, the display processing unit 613 displays, on the first customer touch panel 25, a rewards card entry image in which the customer performs the entry of rewards cards. For example, on the basis of the fact that the customer operation processing unit 611 has confirmed the operation regarding the selection of whether or not to purchase a shopping bag, the display processing unit 613 displays the rewards card entry image on the first customer touch panel 25. The rewards card entry image is, for example, the customer operation image Ime shown in FIG. 9. The customer operation processing unit 611 changes the status to the operating status with respect to the operation regarding the entry of rewards cards.

In ACT 107, the customer operation processing unit 611 determines whether or not the customer's instruction indicating that the customer has a rewards card has been acquired. For example, on the basis of the fact that an operation on the “Yes” button Bf on the customer operation image Ime has been detected, the customer operation processing unit 611 determines that the instruction indicating that the customer has a rewards card has been acquired. On the basis of the fact that an operation on the “No” button Bg in the customer operation image Ime has been detected, the customer operation processing unit 611 determines that an instruction indicating that the customer does not have a rewards card has been acquired. In a case where the customer operation processing unit 611 determines that the instruction indicating that the customer has a rewards card has been acquired (ACT 107: YES), the processing shifts from ACT 107 to ACT 108. In this case, the display processing unit 613 displays the customer operation image Imf shown in FIG. 10 on the first customer touch panel 25. In a case where the customer operation processing unit 611 determines that the instruction indicating that the customer does not have a rewards card has been acquired (ACT 107: NO), the processing shifts from ACT 107 to ACT 109.

In ACT 108, the customer operation processing unit 611 acquires card information of the rewards card on the basis of an operation by the customer. For example, the customer operation processing unit 611 acquires the card information of the rewards card on the basis of the customer's operation of scanning the rewards card.

In ACT 109, the customer operation processing unit 611 confirms the operation regarding the entry of rewards cards. For example, the customer operation processing unit 611 confirms the operation regarding the entry of rewards cards on the basis of the fact that a touch operation on the “Next” button Bh in the customer operation image Imf has been detected. The customer operation processing unit 611 changes the status to the operation end status with respect to the operation regarding the entry of rewards cards. The customer operation processing unit 611 confirms the operation regarding the entry of rewards cards on the basis of the fact that a touch operation on the “No” button Bg in the customer operation image Imf has been detected in ACT 107. In this case, the customer operation processing unit 611 determines that the customer does not have a rewards card with respect to the operation regarding the entry of rewards cards. The customer operation processing unit 611 changes the status to the operation end status with respect to the operation regarding the entry of rewards cards.

In ACT 110, the customer operation processing unit 611 saves operation information regarding the confirmed entry of rewards cards. For example, the customer operation processing unit 611 saves the operation information with respect to the operation regarding the entry of rewards cards confirmed in ACT 109 in the customer operation information storage area 82 of the main memory 62.

In ACT 111, the display processing unit 613 displays, on the first customer touch panel 25, a coupon entry image in which the customer performs the entry of coupons. For example, on the basis of the fact that the customer operation processing unit 611 has confirmed the operation regarding the entry of rewards cards, the display processing unit 613 displays a coupon entry image on the first customer touch panel 25. The coupon entry image is, for example, the customer operation image Imh shown in FIG. 12. The customer operation processing unit 611 changes the status to the operating status with respect to the operation regarding the entry of coupons.

In ACT 112, the customer operation processing unit 611 determines whether or not an instruction indicating that the customer has a coupon with a code has been acquired from the customer. For example, on the basis of the fact that the touch operation on the “coupon with code” button Bja in the customer operation image Imh has been detected, the customer operation processing unit 611 determines that the instruction indicating that the customer has a coupon with a code has been acquired. On the basis of the fact that the touch operation on the “coupon with no code” button Bjb in the customer operation image Imh has been detected, the customer operation processing unit 611 determines that an instruction indicating that the customer has a coupon with no code has been acquired. On the basis of the fact that the touch operation on the “No” button Bk in the customer operation image Imh has been detected, the customer operation processing unit 611 determines that the instruction indicating that the customer does not have a coupon has been acquired. In a case where the customer operation processing unit 611 determines that the instruction indicating that the customer has a coupon with a code has been acquired (ACT 112: YES), the processing shifts from ACT 112 to ACT 113. In this case, the display processing unit 613 displays the customer operation image Imi shown in FIG. 13 on the first customer touch panel 25. In a case where the customer operation processing unit 611 determines that an instruction indicating that the customer has a coupon with no code or that the customer does not have a coupon has been acquired (ACT 112: NO), the processing shifts from ACT 112 to ACT 115.

In ACT 113, the customer operation processing unit 611 determines whether or not the customer has scanned the coupon code of the coupon on the basis of an operation by the customer. For example, the customer operation processing unit 611 determines whether or not the customer has performed the operation of scanning the coupon code with the customer scanner 26. In a case where the customer operation processing unit 611 determines that the customer has scanned the coupon code (ACT 113: YES), the processing shifts from ACT 113 to ACT 114. In a case where the customer operation processing unit 611 determines that the customer has not scanned the coupon code (ACT 113: NO), the processing shifts from ACT 113 to ACT 115.

In ACT 114, the customer operation processing unit 611 acquires coupon information from the coupon code. For example, the customer operation processing unit 611 acquires the coupon information on the basis of the fact that the customer has scanned the coupon code with the customer scanner 26. The coupon information includes discount information such as discount rates and discount amounts of the commodities.

In ACT 115, the customer operation processing unit 611 confirms the operation regarding the entry of coupons. For example, on the basis of the fact that a touch operation on the “No” button Bka in the customer operation image Imi-1 has been detected, the customer operation processing unit 611 confirms the operation regarding the entry of coupons. The customer operation processing unit 611 changes the status to the operation end status with respect to the operation regarding the entry of coupons. The customer operation processing unit 611 confirms the operation regarding the entry of coupons on the basis of the fact that a touch operation on the “No” button Bk in the customer operation image Imh has been detected in ACT 112. In this case, the customer operation processing unit 611 determines that the customer does not have a coupon with respect to the operation regarding the entry of coupons. The customer operation processing unit 611 changes the status to the operation end status with respect to the operation regarding the entry of coupons. The customer operation processing unit 611 may confirm the operation regarding the entry of coupons on the basis of the fact that a touch operation on the “coupon with no code” button Bjb in the customer operation image Imh has been detected in ACT 112. In this case, the customer operation processing unit 611 changes the status to the intervention-required status with respect to the operation regarding the entry of coupons. The customer operation processing unit 611 confirms the operation regarding the entry of coupons on the basis of the fact that a touch operation on the “Cancel” button Bm in the customer operation image Imi has been detected in ACT 113.

In ACT 116, the customer operation processing unit 611 saves operation information regarding the confirmed entry of coupons. For example, the customer operation processing unit 611 saves the operation information with respect to the operation regarding the entry of coupons confirmed in ACT 115 in the customer operation information storage area 82 of the main memory 62.

In ACT 117, the display processing unit 613 displays, on the first customer touch panel 25, a gift card entry image in which the customer performs the entry of gift cards, etc. For example, on the basis of the fact that the customer operation processing unit 611 has confirmed the operation regarding the entry of coupons, the display processing unit 613 displays the gift card entry image on the first customer touch panel 25. The gift card entry image is, for example, the customer operation image Imk shown in FIG. 16. The customer operation processing unit 611 changes the status to the operating status with respect to the operation regarding the entry of gift cards, etc.

In ACT 118, the customer operation processing unit 611 determines whether or not an instruction indicating that the customer has a gift card with a code has been acquired from the customer. For example, on the basis of the fact that a touch operation on the “gift card with code” button Bna in the customer operation image Imk has been detected, the customer operation processing unit 611 determines that the instruction indicating that the customer has a gift card with a code has been acquired. On the basis of the fact that a touch operation on the “gift card with no code” button Bnb in the customer operation image Imk has been detected, the customer operation processing unit 611 determines that an instruction indicating that the customer does not have a gift card with a code has been acquired. On the basis of the fact that a touch operation on the “No” button Bo in the customer operation image Imk has been detected, the customer operation processing unit 611 determines that the instruction indicating that the customer does not have a gift card has been acquired. In a case where the customer operation processing unit 611 determines that the instruction indicating that the customer has a gift card with a code has been acquired (ACT 118: YES), the processing shifts from ACT 118 to ACT 119. In this case, the display processing unit 613 displays, on the first customer touch panel 25, an image similar to the customer operation image Imi shown in FIG. 13. In a case where the customer operation processing unit 611 determines that an instruction indicating that the customer has a gift card with no code or the customer does not have a gift card has been acquired (ACT 118: NO), the processing shifts from ACT 118 to ACT 121.

In ACT 119, the customer operation processing unit 611 determines whether or not the customer has scanned the code of the gift card on the basis of an operation by the customer. For example, the customer operation processing unit 611 determines whether or not the customer has performed the operation of scanning the code with the customer scanner 26. In a case where the customer operation processing unit 611 determines that the customer has scanned the code (ACT 119: YES), the processing shifts from ACT 119 to ACT 120. In a case where the customer operation processing unit 611 determines that the customer has not scanned the code (ACT 119: NO), the processing shifts from ACT 119 to ACT 121.

In ACT 120, the customer operation processing unit 611 acquires gift card information from the code. In ACT 120, for example, on the basis of the fact that the customer has scanned the code with the customer scanner 26, the customer operation processing unit 611 acquires the gift card information. The gift card information includes information such as an amount on the gift card and the type of gift card.

In ACT 121, the customer operation processing unit 611 confirms the operation regarding the entry of gift cards, etc. For example, on the basis of the fact that a touch operation on a “No” button in an image similar to the customer operation image Imi-1 has been detected, the customer operation processing unit 611 confirms the operation regarding the entry of gift cards, etc. The customer operation processing unit 611 changes the status to the operation end status with respect to the operation regarding the entry of gift cards, etc. On the basis of the fact that a touch operation on the “No” button Bo in the customer operation image Imk has been detected in ACT 118, the customer operation processing unit 611 confirms the operation regarding the entry of gift cards, etc. In this case, the customer operation processing unit 611 determines that the customer does not have a gift card with respect to the operation regarding the entry of gift cards, etc. The customer operation processing unit 611 changes the status to the operation end status with respect to the operation regarding the entry of gift cards, etc. On the basis of the fact that a touch operation on the “gift card with no code” button Bnb in the customer operation image Imk has been detected in ACT 118, the customer operation processing unit 611 may confirm the operation regarding the entry of gift cards, etc. In this case, the customer operation processing unit 611 changes the status to the intervention-required status with respect to the operation regarding the entry of gift cards, etc. For example, on the basis of the fact that an input to a “Cancel” button in an image similar to the customer operation image Imi in ACT 119 has been acquired, the customer operation processing unit 611 may confirm the operation regarding the entry of coupons.

In ACT 122, the customer operation processing unit 611 saves operation information regarding the confirmed entry of gift cards, etc. For example, the customer operation processing unit 611 saves the operation information with respect to the operation regarding the entry of coupons confirmed in ACT 121 in the customer operation information storage area 82 of the main memory 62.

In ACT 123, the display processing unit 613 displays, on the first customer touch panel 25, a payment method selection image in which the customer selects a payment method. For example, on the basis of the fact that the customer operation processing unit 611 has confirmed the operation regarding the entry of gift cards, etc., the display processing unit 613 displays the payment method selection image on the first customer touch panel 25. The payment method selection image is, for example, the customer operation image Imm shown in FIG. 18. The customer operation processing unit 611 changes the status to the operating status with respect to the operation regarding the selection of a payment method.

In ACT 124, the customer operation processing unit 611 acquires an instruction to select a payment method from the customer. For example, the customer operation processing unit 611 determines that the instruction to select a payment method has been acquired on the basis of the fact that a touch operation on the payment method-specifying button in the customer operation image Imm has been detected.

In ACT 125, the customer operation processing unit 611 confirms the operation regarding the selection of a payment method. For example, on the basis of the fact that the instruction to select a payment method has been acquired, the customer operation processing unit 611 confirms the operation regarding the selection of a payment method. The customer operation processing unit 611 confirms the payment method on the basis of the selected payment method. The customer operation processing unit 611 changes the status to the operation end status with respect to the operation regarding the selection of a payment method. In a case where the customer has selected the gift card as the payment method, the customer operation processing unit 611 determines that intervention of the store checker is required. The customer operation processing unit 611 changes the status to the intervention-required status with respect to the operation regarding the selection of a payment method.

In ACT 126, the customer operation processing unit 611 saves operation information regarding the confirmed selection of a payment method. For example, the customer operation processing unit 611 saves the operation information with respect to the operation regarding the selection of a payment method confirmed in ACT 124 in the customer operation information storage area 82 of the main memory 62.

It should be noted that the processing procedure of the customer operation items is not limited to the above-mentioned order. The order of the customer operation items may be rearranged and some of the customer operation items may be omitted.

In accordance with this example, the commodity registration apparatus is capable of processing operations by the customer while the store checker is performing the commodity registration. Therefore, the commodity registration apparatus is capable of causing the customer to perform, during the commodity registration, operations which have been conventionally performed by the store checker during the commodity registration or after the commodity registration. Thus, it is possible to shorten the time until the settlement processing starts.

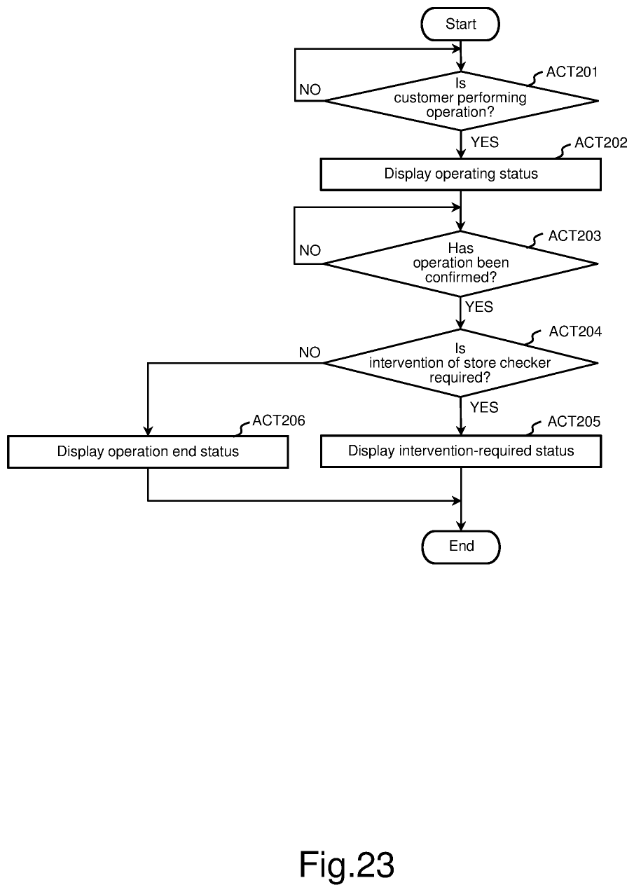

FIG. 23 is a flowchart showing an example of the information processing procedure by the commodity registration apparatus according to the embodiment. FIG. 23 is an example of the processing procedure of updating the store checker image in ACT 3 in FIG. 21. It is assumed that the following processing is performed for each customer operation item.

In ACT 201, the customer operation processing unit 611 determines whether or not the customer is performing an operation. For example, the customer operation processing unit 611 refers to the customer operation information saved in the customer operation information storage area 82 of the main memory 62 and acquires the status for each customer operation item. The customer operation processing unit 611 determines whether or not the status is the operating status with respect to each customer operation item on the basis of the status for each customer operation item. In a case where the customer operation processing unit 611 determines that the status is the operating status (ACT 201: YES), the processing shifts from ACT 201 to ACT 202. In a case where the customer operation processing unit 611 determines that the status is not the operating status (ACT 201: NO), the processing repeats ACT 201.

In ACT 202, the display processing unit 613 displays the operating status in a distinctive manner in the store checker display image. For example, the display processing unit 613 displays the operating status for each customer operation in a distinctive manner in the indicator of the store checker display image. The display of the operating status is an example of the display depending on the progress status of the operation by the customer.

In ACT 203, the customer operation processing unit 611 determines whether or not the customer operation has been confirmed. For example, the customer operation processing unit 611 refers to the customer operation information saved in the customer operation information storage area 82 of the main memory 62 and acquires the status for each customer operation item. On the basis of the status for each customer operation item, the customer operation processing unit 611 determines whether or not the customer operation has been confirmed with respect to each customer operation item. The fact that the customer operation has been confirmed includes the fact that the status is the operation end status and the fact that the status is the intervention-required status. In a case where the customer operation processing unit 611 determines that the customer operation has been confirmed (ACT 203: YES), the processing shifts from ACT 203 to ACT 204. In a case where the customer operation processing unit 611 determines that the customer operation has not been confirmed (ACT 203: NO), the processing repeats ACT 203.

In ACT 204, the customer operation processing unit 611 determines whether or not intervention of the store checker is required with respect to each customer operation item. For example, the customer operation processing unit 611 refers to the customer operation information saved in the customer operation information storage area 82 of the main memory 62 and acquires the status for each customer operation item. On the basis of the status for each customer operation item, the customer operation processing unit 611 determines whether or not the status is the intervention-required status with respect to each customer operation item. The fact that the status is the intervention-required status corresponds to the fact that intervention of the store checker is required. In a case where the customer operation processing unit 611 determines that intervention of the store checker is required (ACT 204: YES), the processing shifts from ACT 204 to ACT 205. In a case where the customer operation processing unit 611 determines that the intervention of the store checker is not required (ACT 204: NO), the processing shifts from ACT 204 to ACT 206.

In ACT 205, the display processing unit 613 displays the intervention-required status in a distinctive manner in the store checker display image. For example, the display processing unit 613 displays the intervention-required status for each customer operation in a distinctive manner in the indicator of the store checker display image. The intervention-required status is an example of notice of the necessary processing.

In ACT 206, the display processing unit 613 displays the operation end status in a distinctive manner in the store checker display image. For example, the display processing unit 613 displays the operation end status for each customer operation in a distinctive manner in the indicator of the store checker display image. The display of the operation end status is an example of display depending on the progress status of the operation by the customer.

In accordance with this example, the commodity registration apparatus is capable of displaying, on the first store checker touch panel 23, the progress status of the operation by the customer, which is performed while the store checker is performing the commodity registration, in a distinctive manner as the store checker display image. Therefore, the commodity registration apparatus enables the store checker to easily check the progress status of the operation by the customer. The store checker can easily recognize the operation performed by the customer and rapidly perform the operation for which intervention of the store checker is required after the commodity registration. Accordingly, the commodity registration apparatus can shorten the time until the settlement processing starts.

### OTHER EMBODIMENTS

The above-mentioned embodiment has been described based on the commodity sales system in which the store checker inputs information associated with purchase commodities, such as barcodes added to the commodities, in the input apparatus, and the customer performs the settlement processing in the settlement processing apparatus, though not limited thereto. For example, the present technology can also be applied to a so-called dual operator commodity sales system in which the store checker inputs information associated with purchase commodities, such as barcodes added to the commodities, in the input apparatus and the store checker performs the settlement processing in the settlement processing apparatus. Moreover, the present technology can also be applied to a semi-self commodity sales system in which a single apparatus is provided with the store checker display arranged on the store checker side to face the store checker and the customer display arranged on the customer side to face the customer. In this case, it is an apparatus by which the store checker inputs information associated with purchase commodities, such as barcodes added to the commodities, by using the store checker display and the customer him- or herself performs the settlement processing by using the customer display. Moreover, the present technology can also be applied to a registration apparatus in a commodity sales system including the registration apparatus by which the store checker inputs information associated with purchase commodities, such as barcodes added to the commodities, and performs the commodity registration and a settlement apparatus by which the customer him- or herself performs the settlement processing with respect to transaction data in which commodities have been registered by this registration apparatus.

The plurality of functions of the commodity registration apparatus may be realized by a single electronic apparatus or may be realized by a plurality of electronic apparatuses.

The above-mentioned embodiment may be applied not only to the apparatus, but also to a method executed by the apparatus. The above-mentioned embodiment may be applied to a program that enables a computer of the apparatus to execute the respective functions. The above-mentioned embodiment may be applied to a recording medium for storing the program.

The program may be delivered in a state stored in the electronic apparatus or may be delivered in a state not stored in the electronic apparatus. In the latter case, the program may be delivered via the network or may be delivered in a state recorded on a recording medium. The recording medium is a tangible non-transitory medium. The recording medium is a computer-readable medium. The recording medium only needs to be a medium capable of storing the program and readable by the computer, such as a CD-ROM or a memory card, and can take any form.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A commodity registration apparatus that registers a commodity to be purchased by the customer, comprising:
a customer display device that displays a customer display image including various types of customer information and receives an operation by the customer;
a store checker display device that displays a store checker display image including various types of store checker information and receives an operation by the store checker; and
a processor configured to
acquire, during commodity registration in one transaction, information regarding the operation by the customer, which is received by the customer display device, and
display, on a basis of the acquired information regarding the operation by the customer, information indicating a progress status of the operation by the customer on the store checker display device.

2. The commodity registration apparatus according to claim 1, wherein
the processor displays the information indicating the progress status of the operation by the customer on the store checker display device for each of a plurality of customer operation items.

3. The commodity registration apparatus according to claim 2, wherein
the information displayed for each of the customer operation items displayed on the store checker display device includes information about a customer operation start status, a customer operating status, and a customer operation end status.

4. The commodity registration apparatus according to claim 2, wherein
the information displayed for each of the customer operation items displayed on the store checker display device includes information about an intervention-required status in which intervention of the store checker is required.

5. The commodity registration apparatus according to claim 1, further comprising
a main memory having a customer operation information storage area, wherein
the customer operation information storage area is an area for storing the information regarding the operation by the customer based on the operation by the customer, and
the processor stores the acquired information regarding the operation by the customer in the customer operation information storage area of the main memory.

6. The commodity registration apparatus according to claim 1, wherein
the processor displays on the store checker display device the information indicating the progress status of the operation by the customer in a distinctive manner in accordance with the progress status.

7. The commodity registration apparatus according to claim 1, wherein
the processor displays information about notice of necessary processing on the store checker display device on a basis of the acquired information regarding the operation by the customer.

8. The commodity registration apparatus according to claim 7, wherein
in a case where the acquired information regarding the operation by the customer includes information about an intervention-required status in which intervention of the store checker is required, the processor displays the information about the notice of the necessary processing on the store checker display device.

9. The commodity registration apparatus according to claim 1, wherein
the processor displays the information regarding the operation by the customer as a list on the store checker display device after a subtotal in the one transaction is registered.

10. An information processing method for a commodity registration apparatus that registers a commodity to be purchased by the customer, comprising:
receiving, by a customer display device that displays a customer display image including various types of customer information, an operation by the customer;
acquiring, during commodity registration in one transaction, information regarding the operation by the customer, which is received by the customer display device; and
displaying on a store checker display device that displays a store checker display image including various types of store checker information and receives an operation by the store checker, information indicating a progress status of the operation by the customer on a basis of the acquired information regarding the operation by the customer.
